(19) United States
(12) Patent Application Publication
(10) Pub. No.: US 2026/0025351 A1
(43) Pub. Date: Jan. 22, 2026

(54) PROMPT GENERATION FOR A VIRTUAL ARTIFICIAL INTELLIGENCE ASSISTANT USED FOR MESSAGE DELIVERY MANAGEMENT

(71) Applicant: Twilio Inc, San Fancisco, CA (US)

(72) Inventors: Lohit Pratap Singh, Seattle, WA (US); Alireza Farasat, Danville, CA (US); Amit Mahajan, Fremont, CA (US); Fiodar Ryzhykau, North Bend, WA (US); Sergio d. Leottau Sanmiguel, Alpharetta, GA (US); Jason Willems, San Francisco, CA (US); Vijay Srikrishna Bhat, Portland, OR (US); Ripal Bhavesh Bhavsar, Cincinnati, OH (US); Esha Omprakash Bharadwaj, Seattle, WA (US); Jiyeon Kang, Brooklyn, NY (US)

(21) Appl. No.: 18/774,423

(22) Filed: Jul. 16, 2024

(51) Int. Cl. H04L 51/216; G06F 9/54

(52) U.S. Cl. CPC H04L 51/216; G06F 9/547

(57) ABSTRACT

A software as a service (SaaS) platform receives a first indication identifying an initialization, at a user device, of a virtual artificial intelligence (AI) assistant for message delivery management at the SaaS platform. A user input identifying a query with first unstructured data is received via the virtual AI assistant and at the SaaS platform. A first prompt identifying the first unstructured data of the query and an identifier of a function related to the message delivery management at the SaaS platform is sent via a first application programming interface (API) call to a generative AI model. A first output of the generative AI model identifying first structured data related to the message delivery management based on the function is received.

### TECHNICAL FIELD

Aspects and embodiments of the disclosure relate to computer software, and more specifically, to systems and methods for prompt generation for a virtual artificial intelligence (AI) assistant used for message delivery management.

### BACKGROUND

A virtual AI assistant can leverage advanced natural language processing (NLP) and machine learning algorithms to interact with users through text or voice interfaces. The virtual AI assistant can perform a variety of tasks, including scheduling appointments and answering queries. By utilizing cloud-based services, a virtual AI assistant can perform real-time data processing and integration with other applications and platforms.

### BRIEF DESCRIPTION OF THE DRAWINGS

Aspects and embodiments of the disclosure will be understood more fully from the detailed description given below and from the accompanying drawings of various aspects and embodiments of the disclosure, which, however, should not be taken to limit the disclosure to the specific aspects or embodiments, but are for explanation and understanding.

FIG. 1A illustrates an example system architecture, in accordance with some embodiments of the disclosure.

FIG. 1B illustrates a high-level component diagram of an example system architecture, system, for a virtual AI assistant that uses a generative AI model, in accordance with aspects of the disclosure.

FIG. 2 illustrates a sequence diagram for implementing a virtual AI assistant, in accordance with some embodiments of the disclosure.

FIG. 3A illustrates a virtual AI assistant user interface, in accordance with some embodiments.

FIG. 3B illustrates a response with structured data based on a function, in accordance with some embodiments.

FIG. 3C illustrates structured data obtained by the SaaS platform, in accordance with some embodiments.

FIG. 3D illustrates a virtual AI assistant user interface, in accordance with some embodiments.

FIG. 4A through 4E illustrate features of an interactive guidance system using a virtual AI assistant, in accordance with some embodiments of the disclosure.

FIG. 5 depicts a flow diagram of an example method for prompt generation for a virtual AI assistant, in accordance with some embodiments of the disclosure.

FIG. 6 is a block diagram illustrating an exemplary computer system, in accordance with some embodiments of the disclosure.

### DETAILED DESCRIPTION

A communication services platform, such as a Software as a Service (SaaS) platform, can offer various communication services to users. For example, a SaaS platform can offer messaging service tools that facilitate messaging conversations, e.g., the sending and/or receiving of messages, such as SMS messages, MMS messages, and/or IM messages, to and from devices via various communication channels. A communication channel can refer to a form of communication that uses one or more of a particular protocol, a particular underlying technology or is provided by a particular entity (e.g., third-party entity). Different communication channels can refer to different forms of communication that can use one or more of different communication protocols, different underlying technologies (e.g., SMS vs IP), or are provided by different entities, such as a third-party entity, that offer services, software or hardware (or a combination thereof) through which messages can be exchanged between recipient devices. For instance, the SaaS platform may send a text message (e.g., SMS message) to a recipient device using a communication channel, such as a telecommunications carrier network or send an instant message to a recipient device using an IM communication channel (e.g., using an application programming interface (API) to communicate with the IM communication channel). Examples of channels can include Public Switched Telephone Network (PSTN) based channels such as SMS or MMS, Internet Protocol (IP) based channels, and proprietary channels (e.g., proprietary social media messaging applications).

To allow users to interact with the aforementioned services, as well as others, a platform can develop and deploy applications that allow client devices associated with the users to interact with the platform. The SaaS platform can include a low-code or no code environment that allows users to coordinate, execute and troubleshoot communication services. Coordinating, executing, and troubleshooting a SaaS services, such as a messaging service can be challenging at least because information may not be readily available, the problem(s) and/or solution(s) may be poorly understood, and the complexity of the messaging service can be high, especially in view of the numerous customizable and customized features implemented by an organization.

In some cases, a virtual artificial intelligence (AI) assistant that uses a generative AI model can be used to assist a user in various tasks, such as coordinating, executing and troubleshooting. However, a generative AI model may generate natural language responses (e.g., unstructured responses) containing general information that is often not domain specific and that may not pertain to the specific client data, specific SaaS service or even the SaaS platform. In some cases, the natural language responses of the generative AI model may not be easily used by or integrated with the SaaS platform.

Aspects of the disclosure address the above-mentioned and other challenges by implementing a virtual artificial intelligence (AI) assistant interface (e.g., also referred to as “virtual AI assistant” herein) that can receive unstructured queries, such as natural language queries regarding for example, message delivery management at the SaaS platform, and provide useful responses, such as responses that include application programming interface (API) calls that are specific to an API endpoint of the SaaS platform. In some embodiments, the virtual AI assistant can guide a user through the complexities of the message service, such as the complexities of message delivery management.

In some embodiments, the SaaS platform can receive the natural language query and generate a modified prompt (e.g. final prompt). The modified prompt can include the user query (e.g., natural language query) and a function identifier, such as a function definition (e.g., one or more function definitions) that defines one or more of a name, parameter(s), description and metadata of the function(s) (e.g., API calls specific to the SaaS platform). The function definition can be defined in a particular schema that is selected and/or specified by the SaaS platform. The SaaS platform can send the modified prompt to the generative AI model for execution. The output of the generative AI model can include a function call based on the function definition. In some embodiments, the function call can include an API call that is defined by the function definition and executable at the SaaS platform. For example, the API call can have a structure defined by the function definition and include the function name, one or more parameters and values corresponding to the one or more parameters. In some embodiments, the values can be generated based on the unstructured user query and/or other contextual information of the modified prompt. In some embodiments, the function call and/or API call can pertain to a database query for retrieving message data related to message delivery management. In some embodiments, by defining the function definition, the SaaS platform guides the generative AI model to produce an output in a structured data format that conforms to the schema defined and/or used by the SaaS platform. In some embodiments, the SaaS platform can use the API call to retrieve message data related to the user query and provide the organization-specific message data for display at the virtual AI assistant (which can also protect sensitive information from being exposed to a third-party generative AI model).

In some embodiments, the API call is used to query one or databases of the SaaS platform to obtain message data in a structured format (e.g., data exchange format). In some instances, the structured format of the message data may not be easily interpretable by a user. The SaaS platform can send part or all of the structured data in a prompt to the generative AI model. The generative AI model can generate an unstructured response (e.g., natural language response) that can be used to populate the virtual AI assistant with relevant message data in natural language (rather than the structured format retrieved by the database query).

In some embodiments, prior to generating the modified prompt as described above, the SaaS platform can determine whether the subject matter of the user query is permitted (e.g., within the scope of the virtual AI assistant). In some embodiments, to determine whether the subject matter of the user query is permitted, the SaaS platform can generate a modified query that includes the user query and a subject matter identifier that indicates the permitted subject matter(s) of the virtual AI assistant. The generative AI model can generate a response to the modified prompt in an unstructured or structured format. The SaaS platform can use the response from the generative AI model to determine whether the subject matter of the user query is permitted. Responsive to determining that the user query includes permitted subject matter, the SaaS platform can generate a modified prompt using the user query and the function identifier, as described above. Responsive to determining that the user query includes unpermitted subject matter, the SaaS platform can send a notification via that virtual AI assistant indicating that the subject matter of the user query is not permitted.

In some embodiments, the user of a client device can initialize the virtual assistant. Responsive to initialization and without a user query, the SaaS platform can identify and retrieve relevant information pertaining to message delivery. For example and in some embodiments, the SaaS platform can identify information pertaining to message delivery failure rates corresponding to the organizational account associated with the user (e.g., user account). In some embodiments, the SaaS platform can identify topics or questions that can help guide the user through message delivery issues. The information can be provided for display at the virtual AI assistant upon initialization at the client device.

As noted, a technical problem addressed by some embodiments of the disclosure is generating prompts for a generative AI model.

A technical solution to the above-identified technical problem(s) may include generating a modified prompt that includes a user query and a function identifier, such as a function identifier that includes a function definition in a structured format.

Thus, the technical effect may include guiding a generative AI model, using a modified prompt, to generate an output in a specific structured format.

A virtual AI assistant can refer to a software application that uses artificial intelligence (AI) technologies, such as a generative AI model, to perform tasks and provide services for users. The tasks can range from simple administrative functions, like setting reminders and sending messages, to more complex activities, such as providing customer support, helping users manage services or engaging in natural language conversations.

Message data can refer to information pertaining to messages, and in particular messages sent and received via the SaaS platform. In some embodiments, the message data pertains to messages of one or more of short messaging service (SMS) channel, a multimedia messaging service (MMS) channel, or an instant messaging service channel.

Structured data can refer to information that is organized in a predefined manner. In some embodiments, structured data adheres to a schema or format. For example, rows and columns in a table and data interchange formatted data are examples of structured data.

Unstructured data can refer to information that lacks a predefined format or structure. In some embodiments, unstructured data can include a variety of formats and types. Examples of unstructured data includes natural language text, videos, images, and audio.

Format can refer to one or more of the structure or arrangement of data, code, or text in accordance with a syntax or set of rules. In some embodiments, the format can define how information is represented, organized and/or processed within a programming environment. Format can include one or more of data format, file format, code format, or protocol format.

It can be appreciated that aspects of the disclosure are described as pertaining to message delivery management for purpose of illustration, rather than limitation. In some embodiments, the aspects of the disclosure can be applied to other areas including, but not limited to other services or features of the SaaS platform, such as account management, voice services, communication services, email services, chat services, and so forth. It can be further appreciated that aspects of the disclosure can be implemented in conversational analytics to analyze and extract meaningful insights from data, such as customer data. That data can be from various channels.

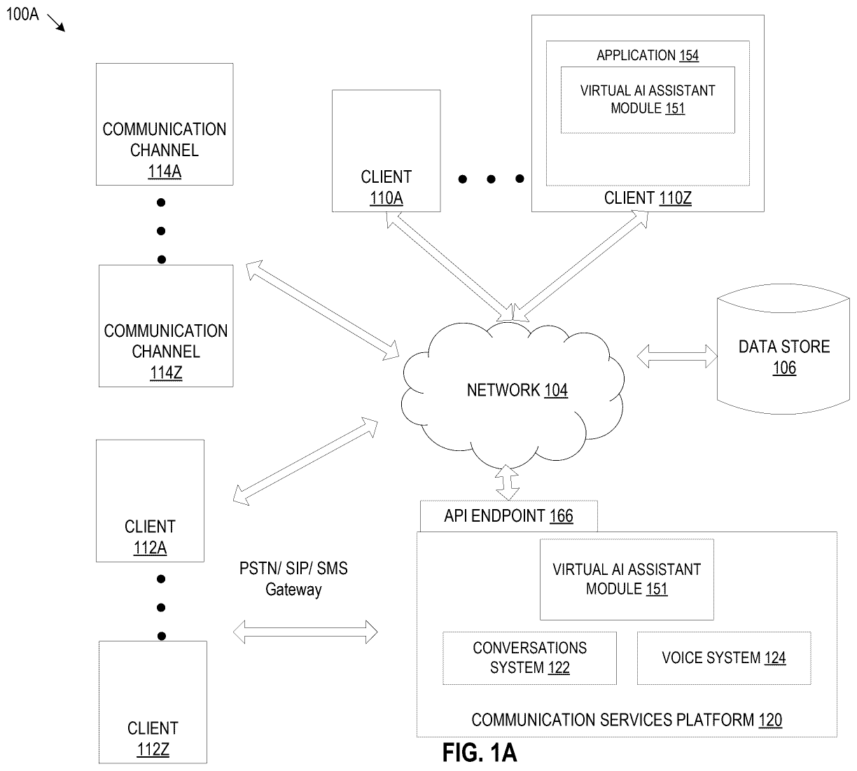

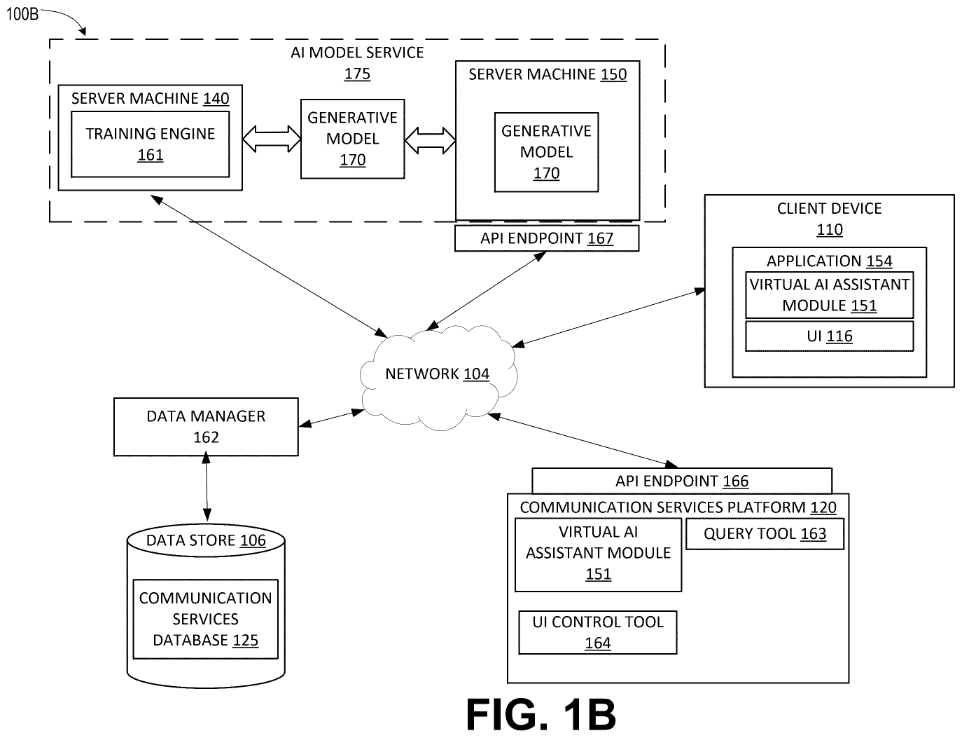

FIG. 1A illustrates an example system architecture 100A, in accordance with some embodiments of the disclosure. The system architecture 100A (also referred to as “system” herein) includes a communication services platform 120, a data store 106, client devices 110A-110Z connected to a network 104, client devices 112A-112Z communicatively coupled to communication services platform 120, and communication channels 114A-114Z coupled to the network 104 (or otherwise communicatively coupled to other elements of the system 100A).

In embodiments, network 104 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some embodiments, data store 106 is a persistent storage that is capable of storing data as well as data structures to tag, organize, and index the data. Data store 106 may be hosted by one or more storage devices, such as main memory, magnetic or optical storage-based disks, tapes or hard drives, NAS, SAN, and so forth. In some embodiments, data store 106 may be a network-attached file server, while in other embodiments data store 106 may be some other type of persistent storage such as an object-oriented database, a relational database, and so forth, that may be hosted by communication services platform 120 or one or more different machines coupled to the communication services platform 120 via the network 104.

The client devices 110A-110Z (generally referred to as “client device(s) 110” herein) may each include a type of computing device such as a desktop personal computer (PCs), laptop computer, mobile phone, tablet computer, netbook computer, wearable device (e.g., smart watch, smart glasses, etc.) network-connected television, smart appliance (e.g., video doorbell), any type of mobile device, etc. In some embodiments, client devices 110 can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components. In some embodiments, client devices 110A through 110Z may also be referred to as “user devices.”

In some embodiments, a client device, such as client device 110Z, can implement or include one or more applications, such as application 154 (also referred to as “client application 154” herein) executed at client device 110Z. In some embodiments, application 154 can be used to communicate (e.g., send and receive information) with communication services platform 120. In some embodiments, application 154 can implement user interfaces (e.g., graphical user interfaces (GUIs)) that may be webpages rendered by a web browser and displayed on the client device 110Z in a web browser window. In another embodiment, the user interfaces of client application 154 may be included in a stand-alone application downloaded to the client device 110Z and natively running on the client device 110Z (also referred to as a “native application” or “native client application” herein).

In some embodiments, client devices 110 can communicate with communication services platform 120 using one or more function calls, such as application programming interface (API) function calls (also referred to as “API calls” herein). For example, the one or more function calls can be identified in a request using one or more application layer protocols, such a HyperText Transfer Protocol (HTTP) (or HTTP secure (HTTPS)), and that are sent to the communication services platform 120 from the client device 110Z implementing application 154. In some embodiments, the communication services platform 120 can respond to the requests from the client device 110Z by using one or more API responses using an application layer protocol. Similarly, communication services platform 120 can communicate with one or more communication channels 114A-114Z using API function calls.

In some embodiments, one or more of client devices 110 can be identified by a uniform resource identifier (URI), such as a uniform resource locator (URL). For example, communication services platform 120 can send an API call to client device 110Z addressed to a URL specific to the client device 110Z. In some embodiments, the communication services platform 120 can be identified by a URI. For instance, the API call sent by a client device 110 to communication services platform 120 can be directed to the URL of communication services platform 120.

In some embodiments, the APIs used to access the conversations system 122 of the communication services platform 120 can be different from the APIs used to access the voice system 124 of communication services platform 120. In some embodiments, the APIs used by application 154 executed on a desktop client device (e.g., desktop application) to access the voice system 124 can be different APIs than the APIs used by application 154 executed on a mobile client device (e.g., mobile application) to access the voice system 124. In some embodiments, conversations system 122 and voice system 124 can communicate between one another using APIs. In some embodiments, the APIs used to communicate between conversations system 122 and voice system 124 may be private APIs that are not accessible by client devices 110 (or client devices 112).

In some embodiments, client devices 112A-112Z (generally referred to as “client device(s) 112” herein) may be similar to client devices 110. In some embodiments, client devices 112 can include one or more telephony devices. A telephony device can include a Public Switched Telephone Network (PSTN)-connected device, such as a landline phone, cellular phone, or satellite phone, for example. In some embodiments, a telephony device can also include an internet addressable voice device (e.g., non-PSTN telephony device), such as Voice-Over-Internet-Protocol (VOIP) phones, or Session Initiation Protocol (SIP) devices, for example. In some embodiments, a telephony device can include one or more messaging devices, such as a Short Message Service (SMS) network device that, for example, uses a cellular service to exchange SMS messages or Multimedia Messaging Service (MMS) messages.

In some embodiments, the communication services platform 120 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components that may be used to provide a user with access to data or services. Such computing devices may be positioned in a single location or may be distributed among many different geographical locations. For example, communication services platform 120 may include a plurality of computing devices that together may comprise a hosted computing resource, a grid computing resource or any other distributed computing arrangement. In some embodiments, communication services platform 120 may correspond to an elastic computing resource where the allotted capacity of processing, network, storage, or other computing-related resources may vary over time.

In some embodiments, communication services platform 120 provides one or more API endpoints 166 that can expose services, functionality or content of the communication services platform 120 to one or more of client devices 110 or communication channels 114A-114Z. In some embodiments, an API endpoint 166 can be one end of a communication channel, where the other end can be another system, such as a client device 110Z or communication channel 114Z. In some embodiments, the API endpoint 166 can include or be accessed using a resource locator, such a universal resource locator (URL), of a server or service. The API endpoint 166 can receive requests from other systems, and in some cases, return a response with information responsive to the request. In some embodiments, HTTP or HTTPS methods can be used to communicate to and from API endpoint 166.

In some embodiments, the API endpoint 166 (also referred to as a “request interface” herein) can function as a computer interface through which communication requests, such as message and/or voice requests, are received and/or created. The communication services platform 120 may include one or more types of API endpoints.

In some embodiments, the API endpoint 166 can include a messaging API and/or voice API whereby external entities or systems can send a communication to create message content and/or request sending of a message and/or request voice services that are provided via voice system 124. The API (e.g., message API and/or voice API) may be used in programmatically creating message content and/or requesting sending of one or more messages and/or requesting the transfer or joining client device(s) to a voice call. In some embodiments, the API is implemented in connection with a multitenant communication service wherein different accounts (e.g., authenticated entities) can submit independent requests. These requests made through the API can be managed with consideration of other requests made within an account and/or across multiple accounts on the communication service.

In some embodiments, the API of the API endpoint 166 may be used in initiating general messaging or communication requests. For example, a messaging request may indicate one or more destination endpoints (e.g., recipient phone numbers), message content (e.g., text and/or media content), and possibly an origin endpoint (e.g., a phone number to use as the “sending” phone number).

In some embodiments, the API of the API endpoint 166 may be any suitable type of API such as a REST (Representational State Transfer) API, a GraphQL API, a SOAP (Simple Object Access Protocol) API, and/or any suitable type of API. In some embodiments, the communication services platform 120 can expose through the API, a set of API resources which when addressed may be used for requesting different actions, inspecting state or data, and/or otherwise interacting with the communication platform.

In some embodiments, a REST API and/or another type of API may work according to an application layer request and response model. An application layer request and response model may use HTTP (Hypertext Transfer Protocol), HTTPS (Hypertext Transfer Protocol Secure), SPDY, or any suitable application layer protocol. Herein HTTP-based protocol is described for purposes of illustration rather than limitation. The disclosure should not be interpreted as being limited to the HTTP protocol. HTTP requests (or any suitable request communication) to the communication services platform 120 may observe the principles of a RESTful design or the protocol of the type of API. RESTful is understood in this document to describe a Representational State Transfer architecture. The RESTful HTTP requests may be stateless, thus each message communicated contains all necessary information for processing the request and generating a response. The API service can include various resources, which act as endpoints that can specify requested information or requesting particular actions. The resources can be expressed as URI's or resource paths. The RESTful API resources can additionally be responsive to different types of HTTP methods such as GET, PUT, POST and/or DELETE.

In some embodiments, the API endpoint 166 can include a request instruction module that can be called within an application, script, or other computer instruction execution. For example, a computing platform may support the execution of a set of program instructions where at least one instruction within a script or other application logic is used in specifying a message request and communicating that request.

In some embodiments, the API endpoint 166 can include a console, administrator interface, or other suitable type of user interface. Such a user-facing interface can be a graphical user interface. Such a user interface may additionally work in connection with a programmatic interface.

In some embodiments, a request, such as a message request, can include a data object characterizing the properties of a message. In some embodiments, the communication services platform 120 is associated with message requests that are programmatically initiated (e.g., an application-to-person (A2P) message). In some embodiments, the message request could be one initiated from an inbound received message.

In some embodiments, a request (e.g., message request and/or voice request) can include one or more of one or more destination endpoints, one or more origin endpoints, and message content and/or audio content. In some embodiments, one or more of these properties may be specified indirectly such as through system or account configuration or identifier (e.g., messaging conversation identifier). For example, all messages may be automatically assigned an origin endpoint that is associated with an account. In some embodiments, the message content can include any suitable type of media content including, text, audio, image data, video data, multimedia, interactive media, data, and/or any suitable type of message content.

In an illustrative example, used for illustration rather than limitation, communication services platform 120 can include a Software as a Service (SaaS) platform that can at least in part provide one or more services, such as communication services, to one or more clients. The SaaS platform may deploy services, such as software applications, to one or more clients for use as an on-demand service. For example, the SaaS platform may deliver and/or license software applications on a subscription basis while also hosting, at least in part, the software application. The licensed software applications can, at least in part, be hosted on the infrastructure, such as the cloud computing resources of the SaaS platform.

In some embodiments, communication services platform 120, as noted above, can provide communication services that include, but are not limited to, voice services, messaging services (e.g., SMS services or MMS services), email services, video services, chat messaging services (e.g., internet-based chat messaging services), or a combination thereof. Communication operations using the communication services can use one or more of a communication network (e.g., Internet), telecommunications network (e.g., such as a cellular network, satellite communication network, or landline communication network), or a combination thereof, to transfer communication data between parties.

In some embodiments, the conversations system 122 can function to interface with one or more communication network(s) and/or service(s) for communication of a conversation (e.g., a messaging conversation, such as SMS, MMS, and/or chat messaging). In some embodiments, the conversations system 122 can include an interface to one or more carrier-based communication routes used in sending SMS, MMS, and/or other carrier-based messages. There may be multiple carrier-based communication routes that serve as different optional “routes” when sending communications over a carrier-based network (e.g., a mobile network). The conversations system 122 may additionally or alternatively include an interface to one or more over-the-top (OTT) communication channels which may be offered by a third-party messaging platform (e.g., proprietary social media messaging, messaging applications, etc.).

A route can refer to a communication delivery path, defined by a series of one or more of computers, routers, gateways and/or carrier networks through which the communication is transferred from a source computer to a destination computer (e.g., through which the transmission of a message occurs). For example, the same route may be used to transfer messages using different communication channels, and the same communication channel may be used to transfer messages using different routes. In some example embodiments, different channels correspond to different applications on a receiving device. For example, a smart phone may have one application to handle SMS messages, another application to handle email, and a third application to handle voicemail. Alternatively, some applications may handle multiple communication channels. For example, one application may handle both SMS and MMS messages.

In some embodiments, when the conversations system 122 elects to send a message using a carrier-based channel, the message is communicated to an appropriate carrier connection for routing to the destination endpoint. Carrier-based channels can use SMPP (Short Message Peer-to-Peer protocol) for communicating to an aggregator or another suitable gateway such that the SMS/MMS message is transferred over a carrier network. Once transmitted to the carrier network, the message can be relayed appropriately to arrive at the intended destination. A message in transit may have multiple routing segments that are used in the delivery to an end destination device.

For example, the conversations system 122 can include an interface to one or more SMS Gateways that enable a computer to send and receive SMS text messages to and from a SMS capable device over the global telecommunications network (normally to a mobile phone). The SMS Gateway translates the message sent and makes it compatible for delivery over the network to be able to reach the recipient. The different SMS gateways (or more generally message gateways) can serve as different route options when the conversations system 122 is determining a channel and/or route to be used for one or more message transmissions.

In some embodiments, SMS Gateways can route SMS text messages to the telco networks via an SMPP interface that networks expose, either directly or via an aggregator that sells messages to multiple networks. SMPP, or Short Message Peer-to-Peer, is a protocol for exchanging SMS messages between Short Message Service Centers (SMSCs) and/or External Short Messaging Entities (ESMEs).

In some embodiments, the destination of a message may be used in determining the candidate message routes (and/or channels). For example, a phone number of a destination endpoint or another identifier associated with the intended recipient of the message may be used to identify the destination network of the intended recipient. Each destination network may be assigned a Mobile Country Code (MCC)/Mobile Network Code (MNC) pair that identifies the specific destination network.

In some embodiments, communication services platform 120 includes a conversations system 122 that can use the phone number associated with the intended recipient of the message to lookup the MCC/MCN pair identifying the destination network. For example, the conversations system 122 can determine the MCC/MNC pair using an MCC/MNC directory that lists the MCC/MNC pair corresponding to each phone number. In some embodiments, the MCC/MNC directory may be stored in a routing provider storage. Alternatively, the MCC/MNC directory may be stored at some other network accessible location. In either case, the conversations system 122 can use the phone number associated with the intended recipient of the message to query the MCC/MNC directory and identify the MCC/MNC pair that identify the corresponding destination network.

In some embodiments, the conversations system 122 can use the MCC/MNC pair retrieved from the MCC/MNC directory to identify candidate routing providers and routes that are available to deliver a message to the destination network identified by MCC/MNC pair. For example, the routing provider storage may include a routing provider directory that lists each MCC/MNC pair serviced by the conversations system 122 and the corresponding routing providers and routes available for use with each MCC/MNC pair. That is, the routing provider directory can list the routing providers and routes that are available to the conversations system 122 to deliver messages to the destination network identified by each MCC/MNC pair listed in the routing provider directory.

In some embodiments, voice system 124 of communication services platform 120 can enable the placement of an outbound voice call and/or routing of an inbound voice call. A voice call (also referred to as a “call” herein) can refer to a telephone call between at least two user devices to communicate two-way voice data (e.g., voice sound) in real-time. An outbound voice call can refer to a voice call from a client device 110 associated with an account (e.g., one or more of an organization's account or user account) of the communication services platform 120, and to another device that may not be associated with an account. An inbound voice call can refer to a voice call from a device that may not be associated with an account, and to a client device 110 associated with an account. It can be appreciated that a voice call between two client devices 110 that are associated with an account can be performed using communication services platform 120. Such voice calls can be considered inbound or outbound voice calls relative to the particular client device 110.

In some embodiments, voice system 124 can include one or more voice services used in conjunction with a voice call. In some embodiments, the one or more voice services can include a transcription service that transcribes speech to text. In some embodiments, the one or more voice services can include a recording service that can record the audio data of the voice call. In some embodiments, the one or more voice services can include a voice call queue service that can queue inbound voice calls and release the queued voice call pursuant to user-defined logic. In some embodiments, the one or more voice services can include voice mailbox services that store voice messages of at least inbound calls. In some embodiments, the one or more voice services can include an interactive voice response (IVR) service that interacts with callers and gathers information for them by giving the callers choices via a menu, and then performs the actions based on the answers of the caller through the telephone keypad or through voice response. For example, the IVR service can allow a caller to interact with the back-end telephony system, such as voice system 124, by pressing keys that emit dual-tone multi-frequency (DTMF) signals or saying words that are processed by a speech recognition system. In some embodiments, the one or more voice services can include a conference call service that can connect three or more devices in a single call.

In some embodiments, communication services platform 120 can include a multitenant system. Multitenancy can refer to a mode of operation of software applications where multiple independent instances of one or multiple applications operate in a shared computer environment. In some embodiments, the instances (tenants) can be logically isolated, but physically integrated. The degree of logical isolation can be complete, but the degree of physical integration can vary. The tenants (application instances) can be representations of organizations that obtain access to the multitenant system. The tenants may also be multiple applications competing for shared underlying resources. Multiple organizations can access the resources of communication services platform 120 without any indication that the resources are shared between the multiple organizations. The data of each of the organizations can be logically isolated from one another such that each organization has access to their own data but not the data of other organizations in the multitenant system. In some embodiments, communication services platform 120 can include a single tenant system.

An organization can be an example of an entity, such as a legal entity, that includes multiple people and that has a particular purpose. A non-limiting example of an organization includes a corporation (e.g., authorized by law to act as a single entity or legal entity). In some embodiments, multiple organizations can include one or more organizations that are independent or distinct from the other organizations. For example, a first organization can be corporation A and a second organization can be corporation B. Corporation A can be considered an independent legal entity from corporation B. Each of corporation A and corporation B can make independent decisions and have a different legal or corporate structure.

In some embodiments, a “user” may be represented as a single individual. However, other embodiments of the disclosure encompass a “user” being an entity controlled by a set of users and/or an automated source. For example, a set of individual users federated as one or more departments in an organization may be considered a “user.” In general, functions described in one embodiment as being performed by the communication services platform 120 can also be performed on the client devices 110A through 110Z in other embodiments (and vice versa), if appropriate. In addition, the functionality attributed to a particular component can be performed by different or multiple components operating together. The communication services platform 120 can also be accessed as a service provided to other systems or devices through appropriate APIs.

As noted above and in some embodiments, a communication channel can refer to an entity, such as a third-party entity (e.g., organizations different from communication services platform 120), that offers services, software or hardware (or a combination thereof) through which messages can be sent to recipient devices. (e.g., organizations different from communication services platform 120). A third party can refer to an entity, such as organization or business (e.g., a different legal entity than communication services platform 120) that is distinct from another entity, such as the entity controlling or owning the communication services platform 120. In some embodiments, the communication services offered by communication channels 114A-114Z can be integrated into communication services platform 120. In some embodiments, the communication services offered by communication channels 114A-114Z can include messaging services. In some embodiments, messaging services can include one or more of a short messaging service (SMS) offered by an SMS channel, a multimedia messaging service (MMS) offered by an MMS channel, or an instant messaging service (e.g., chat messaging) offered by an instant messaging service channel. In some embodiments, communication channels 114A-114Z can also include a voice channel. For example, the voice channel may implement an application to send or receive calls. In another example, the voice channel may include a telecommunication service provider and/or PSTN voice services.

In some embodiments, an instant messaging service is different from an electronic mail (email) service. In some embodiments, the communication channels 114A-114Z can include an email channel. In some embodiments, the communication channels 114A-114Z exclude an email channel. In some embodiments, email messages can use a standard protocol for sending and receiving email messages. The standard protocol can be used across different platforms. In some embodiments, instant messages can use protocols specific to a platform that may or may not be compatible with other platforms. In some embodiments, instant messaging can differ from email in that conversations over instant messaging can happen in real-time, while conversations over email are not in real-time.

In some embodiments, communication services platform 120 and/or client devices 110 include an instance of virtual artificial intelligence (AI) assistant module 151. In some embodiments, virtual AI assistant module 151 of client device 110Z, of communication services platform 120, of server machine 150 of FIG. 1B, of AI model service 175 (where virtual AI assistant module is not illustrated) or a combination thereof can perform one or more aspects or embodiments of the disclosure.

In some embodiments, an entity (e.g., organization) can be associated with an account (e.g., organizational account) of communication services platform 120. Within the particular account (e.g., organizational account) of the organization, one or more user accounts of the communication services platform 120 may be associated with different users of the organization. In some embodiments, the accounts are organized in a hierarchical structure where the organizational account is the root at the top of the hierarchy and the user accounts are nested under the organizational account.

In some embodiments, communication services platform 120 can provision telephone numbers (e.g., 10-digit long code or short code) to an organization's account and assign the telephone numbers to various user accounts associated with the organization. The assignment of telephone numbers can be flexible such that the assignment of a telephone number can be one to one (e.g., one telephone number to one user account) or one to many (e.g., one telephone number to many user accounts).

In some embodiments, communication services platform 120 can dynamically assign or transfer the telephone numbers. For example, user account A may be assigned telephone number A. Telephone number A can be transferred and assigned to another user account Z and unassigned from user account A, or can be assigned to user account Z and user account A, for instance.

In some embodiments, voice calls and messages can be dynamically routed or sent to and from different telephone numbers. For instance, a user account A may be assigned telephone number A. Telephone number A may have an area code corresponding to Texas. User account A, via application 154 of client device 110A, sends, via communication services platform 120, a message A to an end user device. The end user device can be associated with a telephone number with an area code associated with the state of California. Communication services platform 120 can associate a telephone number with a California area code to the message conversation and send message A to end user device from the associated telephone number with a California area code. From the perspective of the end user device, the message A can appear to be sent from the telephone number with a California area code, rather than from the telephone number A with a Texas area code.

In some embodiments, the telephone number of the client device 110 (e.g., telephone number assigned to the client device 110 by the telecommunications carrier) can be different than the telephone number that is assigned to the user account associated with the client device 110. In some embodiments, the client device 110 may not have a telephone number assigned by a telecommunications carrier. For instance, the client device 110A may be a desktop computer. In some embodiments, the client device 110A can be identified by an internet protocol (IP) address and can send messages of the message conversation using a protocol such as HTTP over TCP/IP (transmission control protocol) or can place a voice call using a Voice over IP (VOIP) protocol (e.g. SIP) via application 154, for example.

Although embodiments of the disclosure are discussed in terms of communication service platforms, embodiments may also be generally applied to any type of platform, system or service.

In situations in which the systems discussed here collect personal information about users, or may make use of personal information, the users may be provided with an opportunity to control whether the communication services platform 120 collects user information, or to control whether and/or how to receive content from the communication services platform 120 that may be more relevant to the user. In addition, certain data may be treated in one or more ways before it is stored or used, so that personally identifiable information is removed. For example, a user's identity may be treated so that no personally identifiable information can be determined for the user generalized where location information is obtained (such as to a city, ZIP code, or state level), so that a particular location of a user cannot be determined. Thus, the user may have control over how information is collected about the user and used by the communication services platform 120.

FIG. 1B illustrates a high-level component diagram of an example system architecture, system 100B, for a virtual AI assistant that uses a generative AI model, in accordance with aspects of the disclosure. It can be noted that elements of system 100A can be used to help describe elements of system 100B. For the sake of clarity and brevity, the description of elements of FIG. 1A can similarly apply to corresponding elements of FIGS. 1B and 1s not repeated here. It can be further noted the description of FIG. 1A can similarly apply to FIG. 1B, unless otherwise described, and is not repeated here for the sake of clarity and brevity.

The system 100B includes a data store 106, a generative AI model 170 trained by server machine 140 and provided to server machine 150, a communication services platform 120, one or more client devices 110, data manager 162 and/or other components connected to a network 104. In some embodiments, system 100B can, at least in part, be a part of or can be included in system 100A, as described above. In some embodiments, generative AI model 170 can be trained in a distributed manner (e.g., server machines 140 in a distributed environment) using an internet scale corpse of data to answer queries. In some embodiments, the models, such as generative AI model 170, can be accessed via API endpoint 167 using an API call.

In some embodiments, an AI model (e.g., also referred to as an “machine learning model” herein) can include a discriminative AI model (also referred to as “discriminative machine learning model” herein), a generative AI model (also referred to as “generative machine learning model” herein), and/or other AI model.

In some embodiments, a discriminative AI model can model a conditional probability of an output for given input(s), A discriminative AI model can learn the boundaries between different classes of data to make predictions on new data. In some embodiments, a discriminative AI model can include a classification model that is designed for classification tasks, such as learning decision boundaries between different classes of data and classifying input data into a particular class. Examples of discriminative AI models include, but are not limited to, support vector machines (SVM) and neural networks.

In some embodiments, a generative AI model learns how the input training data is generated and can generate new data. A generative AI model can model the probability distribution (e.g., joint probability distribution) of a dataset and generate new samples that often resemble the training data. Generative AI models can be used for tasks involving image generation, text generation and/or data synthesis. Generative AI models include, but are not limited to, gaussian mixture models (GMMs), variational autoencoders (VAEs), generative adversarial networks (GANs), large language models (LLMs), visual language models (VLMs), multi-modal models (e.g., text, images, video, audio, depth, physiological signals, etc.), and so forth.

In some embodiments, the system 100B includes a server machine 150 including a generative AI model 170 (also referred to as “generative AI model,” or “generative model (GM)” herein). In some embodiments, a generative AI model 170 can be trained according based on a corpus of data, as described herein.

In some embodiments, a generative AI model 170 can deviate from some AI models based on the generative AI model's ability to generate new data. As described above, a generative AI model 170 can include a generative adversarial network (GAN) and/or a variational autoencoder (VAE). In some instances, a GAN, a VAE, and/or other types of generative AI models can employ different approaches to training and/or learning the underlying probability distributions of training data, compared to some AI models.

For instance, a GAN can include a generator network and a discriminator network. The generator network attempts to produce synthetic data samples that are indistinguishable from real data, while the discriminator network seeks to correctly classify between real and fake samples. Through this iterative adversarial process, the generator network can gradually improve its ability to generate increasingly realistic and diverse data.

In some embodiments, the generative AI model 170 can be a generative large language model (LLM). In some embodiments, the generative AI model 170 can be a large language model that has been pre-trained on a large corpus of data so as to process, analyze, and generate human-like text based on given input.

In some embodiments, the generative AI model 170 may have any architecture for LLMs, including one or more architectures as seen in Generative Pre-trained Transformer (GPT) series or leverage a combination of transformer architecture with pre-trained data to create coherent and contextually relevant text.

In some embodiments, a generative AI model 170, such as an LLM, can use a transformer including an encoder-decoder architecture with one or more self-attention mechanisms, and one or more feed-forward mechanisms. In some embodiments, the generative AI model 170 can include an encoder that can encode input textual data into a vector space representation; and a decoder that can reconstruct the data from the vector space, generating outputs with increased novelty and uniqueness. The self-attention mechanism can compute the importance of phrases or words within a text data with respect to all of the text data. A generative AI model 170 can also utilize deep learning techniques, including recurrent neural networks (RNNs), convolutional neural networks (CNNs), or transformers.

In some embodiments, the generative AI model 170 can be a multi-modal generative AI model, such as a Visual-Language Model (VLM). In some embodiments, the generative AI model 170 can be a VLM that has been pre-trained on a large corpus of data (e.g., textual data and image data) so as to process, analyze, and generate human-like text and/or image data based on given input (e.g., image data and/or natural language text).

With respect to generative AI model 170, generative AI model 170 can be trained by server machine 140 (or another server or computing device of system 100B), in some embodiments.

In some embodiments, training a generative AI model can include providing training input to a generative AI model 170, and the generative AI model 170 can produce one or more training outputs. The one or more training inputs can be compared to one or more evaluation metrics. An evaluation metric can refer to a measure used to assess the output (e.g., training output(s)) of an AI model, such as a generative AI model 170. In some embodiments, the evaluation metric can be specific to the task and/or goals of the AI model. Based on the comparison, one or more parameters and/or weights of the generative AI model 170 can be adjusted (e.g., backpropagation based on computed loss function). In some embodiments, and for example, the one or more training outputs can be compared to an evaluation metric such as a ground truth (e.g., target output, such as a correct or better answer). In some embodiments and for example, the one or more training outputs can be evaluated/compared to an evaluation metric and can be rewarded (e.g., evaluated as a positive answer) or penalized (e.g., evaluated as a negative answer) based on the quality of the one or more training outputs (e.g., reinforcement learning).

In some embodiments, a validation engine (not shown) may be capable of validating a generative AI model 170 using a corresponding set of features of a validation set from the training set generator. In some embodiments, the validation engine may determine an accuracy of each of the trained generative models, such as generative AI model 170 (e.g., accuracy of the training output) based on the corresponding sets of features of the validation set. The validation engine may discard a trained generative AI model 170 that has an accuracy that does not meet a threshold accuracy. In some embodiments, a selection engine not shown) may be capable of selecting a generative AI model 170 that has an accuracy that meets a threshold accuracy. In some embodiments, the selection engine may be capable of selecting the trained generative AI model 170 that has the highest accuracy of the trained generative models (e.g., generative AI model 170).

A testing engine (not shown) may be capable of testing a trained generative AI model 170 using a corresponding set of features of a testing set from the training engine 141. For example, a first trained generative AI model 170 that was trained using a first set of features of the training set may be tested using the first set of features of the testing set. The testing engine may determine a trained generative AI model 170 that has the highest accuracy of all of the trained AI models based on the testing sets.

In some embodiments, a generative AI model 170 can be trained on a corpus of data, such textual data and/or image data (including video data). In some embodiments, the generative AI model 170 can be a model that is first pre-trained on a corpus of text to create a foundational model (e.g., also referred to as “pre-trained model” herein), and afterwards adapted (e.g., fine-tuned or transfer learning) on more data pertaining to a particular set of tasks to create a more task-specific or targeted generative AI model (e.g., also referred as an “adapted model” herein.) The foundational model can first be pre-trained using a corpus of data (e.g., text and/or images) that can include text and/or image content in the public domain, licensed content, and/or proprietary content (e.g., proprietary organizational data). The generative AI model 170 can use pre-training to learn broad image elements and/or broad language elements including general sentence structure, common phrases, vocabulary, natural language structure, and any other elements commonly associated with natural language in a large corpus of text. In example, the pre-trained model can be fine-tuned to the specific task or domain that the generative AI model 170 is to be adapted. In some embodiments, generative AI model 170 may include one or more pre-trained models or adapted models.

System 100B may further include a data manager 162 that may be any application configured to manage data transport to and from data store 106, e.g., retrieval of data and/or storage of new data, indexing data, arranging data by user, time, type of activity to which the data is related, associating the data with keywords, and/or the like. Data manager 162 may collect data associated with various user activities, e.g., content pertaining communications, applications, internal tools, and/or the like. Data manager 162 may collect, transform, aggregate, and archive such data in data store 106. In some embodiments, data manager 162 can transform data into vector data, such as vector embedding data, and index and store the vector data at data store 106. The data manager 162 can also provide the appropriate vector data to generative AI model (e.g., model 160) for training and inference.

In some embodiments, communication services platform 120 may include query tool 163 (also referred to as “prompt tool 163” herein) configured to perform automated identification and facilitate retrieval of relevant and timely contextual information for quick and accurate processing of user queries (or queries by communication services platform 120) by generative AI model 170. In some embodiments, query tool 163 may be implemented by virtual AI assistant module 151. It can be noted that a user's request for an operation pertaining to communication services platform 120 can be formed into a query (e.g., prompt) that uses query tool 163, in some embodiments. Via the network 104, query tool 163 may be in communication with one or more client devices 110, sever server machine 140, server machine 150, and data store 106, e.g., via data manager 162. Communications between query tool 163 and server machine 150 may be facilitated by an API of server machine 150 (e.g., API endpoint 167). Communications between query tool 163 and data store 106/data manager 162 may be facilitated by an API of the data store 106 and/or the data manager 162. In some embodiments, query tool 163 may generate an intermediate query (e.g., query analyzer) and may translate an intermediate query into unstructured natural-language format (e.g., natural language prompt) and, conversely, translate responses received from generative AI model 170 into any suitable form (including any structured proprietary format as may be primarily used by query tool 163).

In can be noted that a query as provided to a generative AI model can also be referred to as a “prompt” herein. A prompt can refer to an input (e.g., a specific input) or instruction provided to a generative AI model 170 to generate a response. In some embodiments, a prompt can be written, at least in part, in natural language. Natural language can refer a language that is expressed in or corresponds to a way that humans communicate using spoken or written language to convey meaning, express thoughts, and/or interact. In some embodiments, the prompt can specify the information or context the generative AI model 170 can use to produce an output. For example, a prompt can include text, image, or other data that serves as the starting point for the generative AI model 170 to perform a task.

In some embodiments, query tool 163 may include a query analyzer to support various operations. For example, query analyzer may receive a user input, e.g., user query, and generate one or more intermediate queries corresponding to generative AI model 170 to determine what type of data (e.g., user data, beauty product data, etc.) generative AI model 170 might use to successfully respond to the user input. Responsive to receiving a response from generative AI model 170, query analyzer may analyze the response and form a request for relevant contextual data (e.g., contextual information) for data manager 162, which may then supply such data. Query analyzer may then generate a final query (e.g., prompt) to generative AI model 170 that includes the original user query and the contextual data received from data manager 162. In some embodiments, query analyzer may itself include a lightweight generative AI model that may process the intermediate query(ies) and determine what type of contextual data may have to be provided to generative AI model 170 together with the original user query to ensure a meaningful response from generative AI model 170.

For example, and in some embodiments, query tool 163 can implement a retrieval augmented generation (RAG) technique that allows the generative AI model 170 to retrieve data from various sources, such as data store 106. For instance, and in some embodiments, communication services database 125 can include proprietary, domain-specific data and/or organization-specific data, such as data related to communications of a particular organization. Responsive to a user query, the query analyzer can identify specific instructions related to the user query and that instruct the query analyzer to obtain relevant contextual data from communication services database 125. The query analyzer can identify relevant contextual data (e.g., organization-specific communication information etc.) from communication services database 125 and generate a final query that includes the user query and the relevant contextual data. The final query can be provided as a prompt to generative AI model 170 for execution.

In some embodiments, query tool 163 may include (or may have access to) instructions stored on one or more tangible, machine-readable storage media of communication services platform 120 and executable by one or more processing devices of communication services platform 120. In some embodiments, virtual AI assistant module 151, query tool 163, and or generative AI model 170 may be implemented at communication services platform 120. In some embodiments, virtual AI assistant module 151, query tool 163, and/or generative AI model 170 may be a combination of a client component and a server component. In some embodiments, virtual AI assistant module 151, query tool 163, and/or generative AI model 170 may be executed entirely on the client devices 110. Alternatively, some portion of virtual AI assistant module 151, query tool 163, and/or generative AI model 170 may be executed on a client device 110 while another portion of virtual AI assistant module 151, query tool 163, and/or generative AI model 170 may be executed on communication services platform 120.

It can be appreciated that in some embodiments, any element, such as server machine 140, server machine 150, and/or data store 106 may include a corresponding API endpoint for communicating with APIs. For example and embodiments, communication services platform 120 can implement a third-party service that hosts a generative model, such as generative model 170, and associated services. Communication services platform 120 can access the services corresponding to the generative model via API endpoint 167. A third-party can refer to an entity, such as an enterprise or organization (e.g., third-party SaaS service provider) that is distinct and/or external from a first-party entity, such as the communication services platform 120.

In some embodiments, AI model, such as generative AI model 170, may be (or may correspond to) one or more computer programs executed by processor(s) of server machine 140 and/or server machine 150. In other embodiments, AI model may be (or may correspond to) one or more computer programs executed across a number or combination of server machines. For example, in some embodiments, AI models may be hosted on the cloud, while in other embodiments, these AI models may be hosted and perform operations using the hardware of a client device 110. In some embodiments, the AI model may be a self-hosted AI model, while in other embodiments, AI models may be external AI models accessed by an API.

In some embodiments, one or more of server machine 140, server machine 150, and generative AI model 170 can be part of AI model service 175. AI model service 175 can provide AI services via API endpoint 167. For example, communication services platform 120 can request AI services from AI model service 175 such as access to one or more AI models, such as generative AI model 170 via API endpoint 167. In some embodiments, AI model service 175 is a third-party service. In other embodiments, AI model service 175 is a first-party service.

In some embodiments, server machines 140 through 150 can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components that can be used to provide a user with access to one or more data items of the communication services platform 120. The communication services platform 120 can also include a website (e.g., a webpage) or application back-end software that can be used to provide users with access to the communication services platform 120.

In some embodiments, one or more of server machine 140, model 170, server machine 150 can be part of communication services platform 120. In other embodiments, one or more of server machine 140, server machine 150, or model 170 can be separate from communication services platform 120 (e.g., provided by a third-party service provider).

In some embodiments, application 154 can implement user interfaces (UIs) (e.g., graphical user interfaces (GUIs)), such as a user interface (UI) (e.g., UI 116) that may be webpages rendered by a web browser and displayed on the client device 110 in a web browser window. In another embodiment, the UIs 116 of client application, such as application 154 may be included in a stand-alone application downloaded to the client device 110 and natively running on the client device 110 (also referred to as a “native application” or “native client application” herein). In some embodiments, virtual AI assistant module 151 can be implemented as part of application 154. In other embodiments, virtual AI assistant module 151 can be separate from application 154 and application 154 can interface with virtual AI assistant module 151.

In some embodiments, one or more client devices 110 can be connected to the system 100B. In some embodiments, client devices, under direction of the communication services platform 120 when connected, can present (e.g., display) a UI 116 to a user of a respective client device through application 154. The client devices 110 may also collect input from users through input features.

In some embodiments, a UI 116 may include various visual elements (e.g., GUI elements) and regions, and can be a mechanism by which the user engages with the communication services platform 120, and system 100B at large. In some embodiments, the UI 116 of a client device 110 can include multiple visual elements and regions that enable presentation of information, for decision-making, content delivery, etc. at a client device 110. In some embodiments, the UI 116 may sometimes be referred to as a graphical user interface (GUI)).

In some embodiments, the UI 116 and/or client device 110 can include input features to intake information from a client device 110. In one or more examples, a user of client device 110 can provide input data (e.g., a user query, control commands, etc.) into an input feature of the UI 116 or client device 110, for transmission to the communication services platform 120, and system 100B at large. Input features of UI 116 and/or client device 110 can include space, regions, or elements of the UI 116 that accept user inputs. For example, input features may include visual elements (e.g., GUI elements) such as buttons, text-entry spaces, selection lists, drop-down lists, etc. For example, in some embodiments, input features may include a virtual assistant which a user of client device 110 can use to answer natural language queries. The application 154 via client device 110 can then transmit that textual data to communication services platform 120, and the system 100B at large, for further processing. In other examples, input features can include a selection list, in which a user of client device 110 can input selection data e.g., by selecting, or clicking. The application 154 via client device 110 can then transmit that selection data to communication services platform 120, and the system 100B at large, for further processing.

In some embodiments, UI 116 of client device 110 may allow a user to select from multiple (e.g., specialized in particular knowledge areas) of the generative AI models 170. In some embodiments, UI 116 may allow the user to provide consent for query tool 163 and/or generative AI model 170 to access user data previously stored in data store 106 (and/or any other memory device), process and/or store new data received from the user, and the like. UI 116 may allow the user to withhold consent to provide access to user data to query tool 163 and/or generative AI model 170.

In some embodiments, communication services platform 120 and in particular, the UI control tool 164 may perform user-display functionalities of the system such as generating, modifying, and monitoring the client-side UIs (e.g., graphical user interfaces (GUI)) and associated components that are presented to users of the communication services platform 120 through UI 116 client devices 110. For example, virtual AI assistant module 151 via UI control tool 164 can generate the UIs (e.g., UI 116 of client device 110) that users interact with while engaging with the communication services platform 120.

In situations in which the systems discussed here collect personal information about users, or can make use of personal information, the users of client devices 110 can be provided with an opportunity to control whether or how the communication services platform 120 collects user information. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the communication services platform 120.

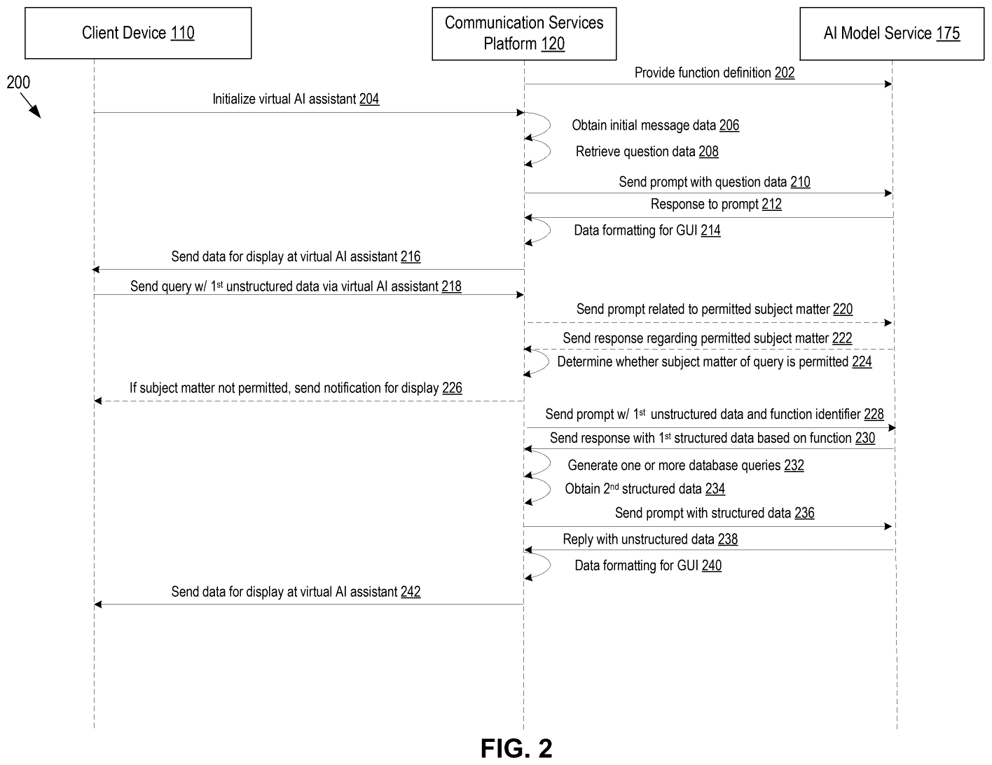

FIG. 2 illustrates a sequence diagram for implementing a virtual AI assistant, in accordance with some embodiments of the disclosure.

Diagram 200 illustrates communication services platform 120, client device 110, and AI model service 175. In some embodiments, one or more of communication services platform 120, AI model service 175, client device 110Z using application 154, and in particular virtual AI assistant module 151 of application 154 can implement respective operations depicted in diagram 200. In some embodiments, client device 110 can represent a client device that corresponds to a user account associated with a user of an organization. In some embodiments, client device 110 can implement application 154 having a GUI where application 154 interacts with the communication services platform 120 to consume various services of the communication services platform 120. It can be appreciated that operations of diagram 200 are provided for illustration, rather than limitation. In some embodiments, all, some or different operations can be performed in the same or different order or performed in parallel.

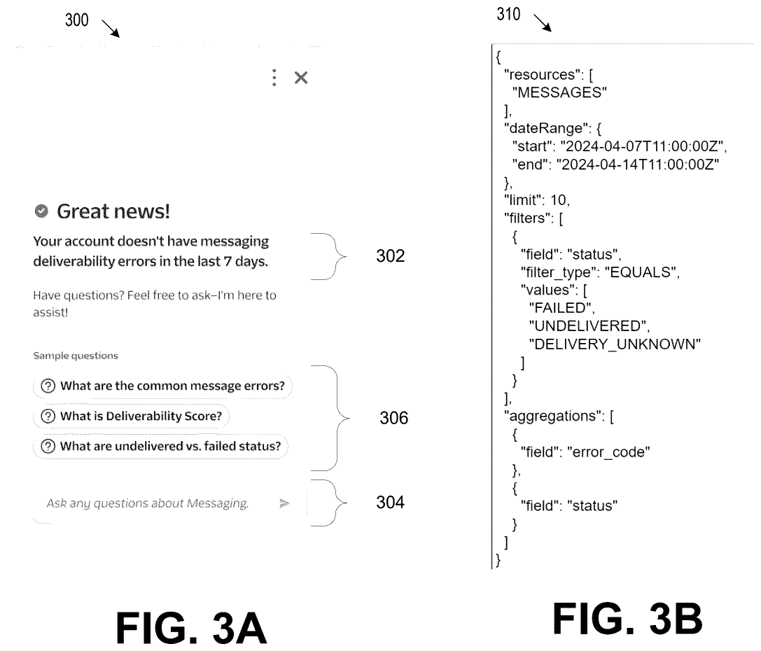

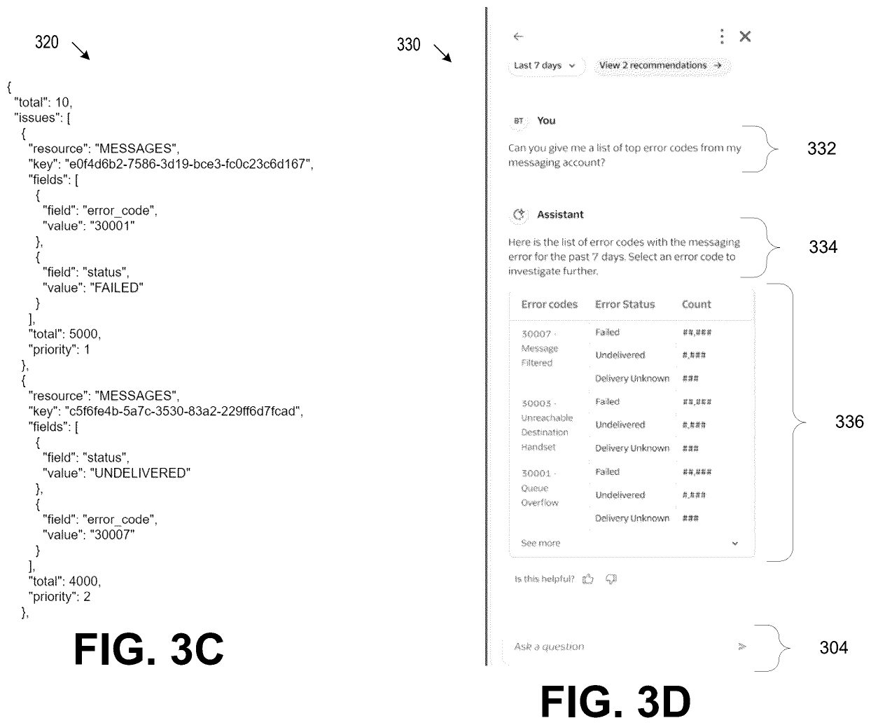

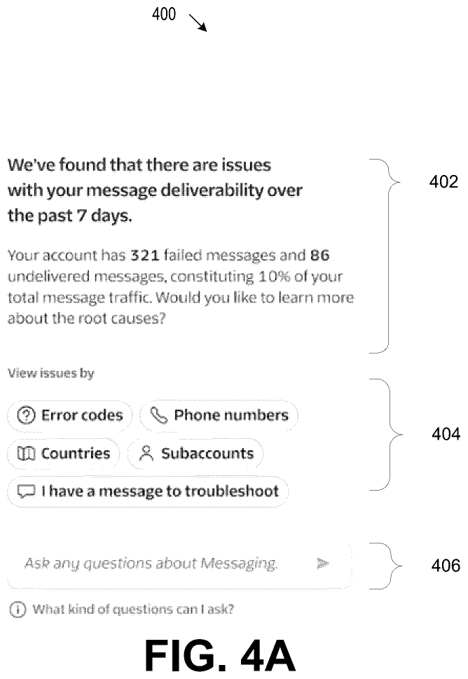

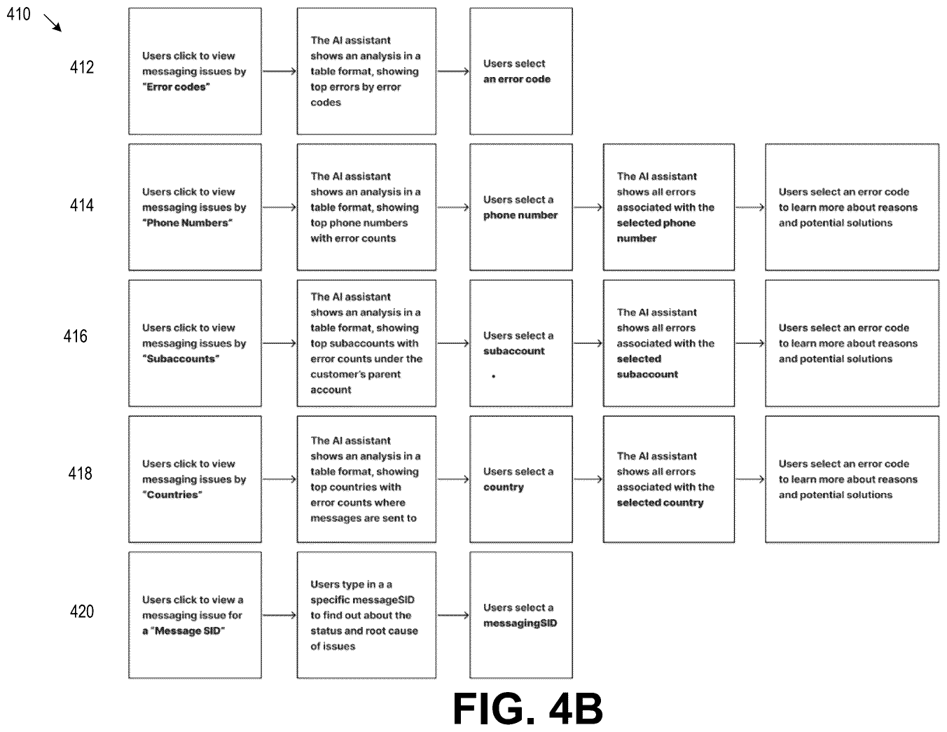

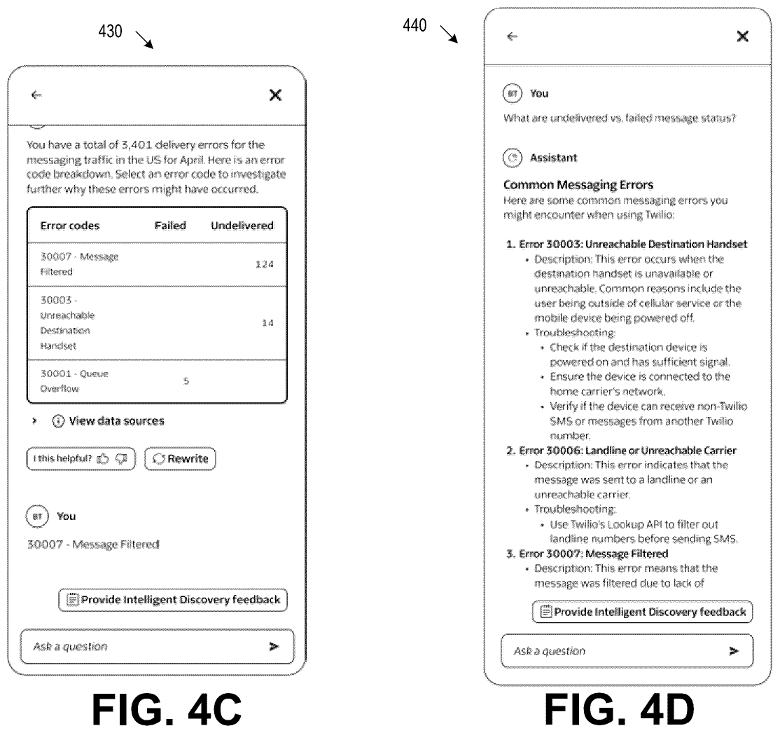

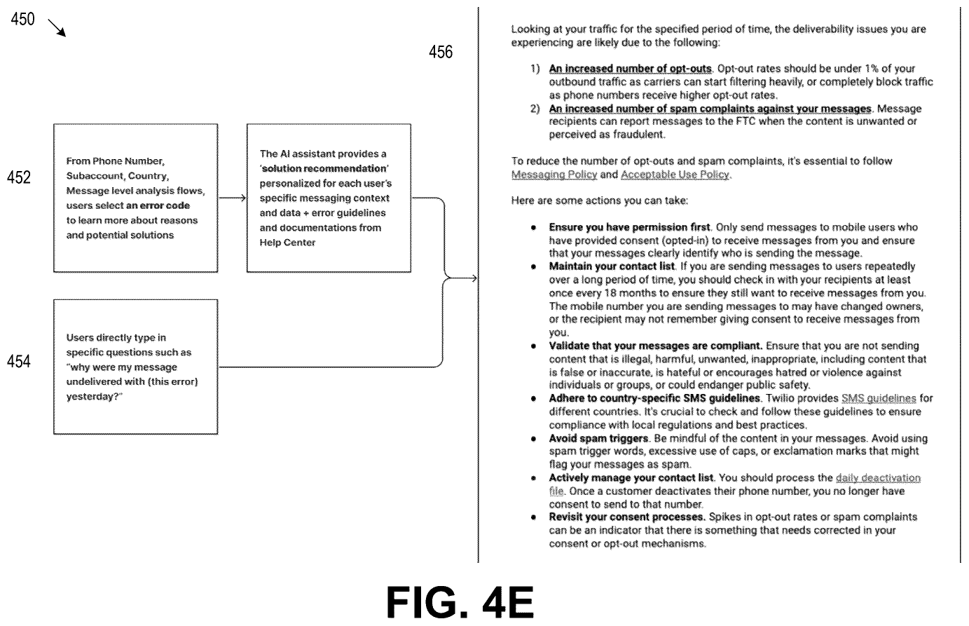

In some embodiments, the virtual AI assistant can be used to implement a “guided flow” where the virtual AI assistant provides information in a manner that guides a user through message delivery management. It can be appreciated that the operations described with respect to FIG. 2 can be used to implement a virtual AI assistant that provides a guided flow. For example and in some embodiments, a virtual AI assistant can include topics and/or questions (e.g., question data), such as questions illustrated by GUI elements 306 of FIG. 3A. The presented topics and/or questions can be displayed as GUI elements via the virtual AI assist and be selected by a user. The topics and/or questions can guide or direct a user through the process of message delivery management. In some embodiments, responsive to a user-selection of a GUI element 306 representing a question and/or topic, the communication services platform 120 can retrieve relevant information (e.g., answer the question) and obtain additional question data (and/or topic data) to render additional questions or topics (e.g., additional GUI elements) that pertain to the initial question selected (e.g., “What are the common message errors?) by the user. The additional questions and/or topics can pertain to the topic selected by the user (e.g., common message errors) and further direct the user through the topic (e.g., through common message errors and related sub-topics). Further examples of guided flow are further described with respect to FIG. 4A through 4E.

In some embodiments, one or more of the communications between communication services platform 120 and AI model service 175 can be implemented using API calls. For example, AI model service 175 can implement an API endpoint to communicate and access the services provided by AI model service 175.

At operation 202, communication services platform 120 sends AI model service 175 a request to create and/or define a function. In some embodiments, the request to create and/or define a function can be performed using an API call. In some embodiments, the function can refer to a unit of code that performs a specific task. In some embodiments, the function definition (also referred to as “API definition” herein) can include a function name and one or more parameters. In some embodiments, the function definition can describe the structure of an API call. In some embodiments, the function definition can specify parameters in a structured format. In some embodiments, the structured format can include types and descriptions. In some embodiments, the function can include a description. A description can describe what the function does. The function description can help the generative machine learning model understand what the task the function performs and how to use the function with respect to a prompt. In some embodiments, the function definition can include metadata (e.g., parameter types and descriptions) that help guide the generative machine learning model in constructing the correct function call (e.g., help the model understand and call the function correctly based on user inputs).

In some embodiments, to define a function, the communication services platform 120 can specify one or more of the name, description, parameter(s) or metadata of the function. In some embodiments, AI model service 175 can store the function. The stored function can be referenced in a subsequent request (e.g., subsequent API call). In other embodiments, the function can be defined within or along with a prompt, as further described at operation 228.

In some embodiments, AI model service 175 does not execute the function. In some embodiments, the AI model service 175 can use the function to generate an output of the generative AI model 170 that suggests or calls the function. The function call be used or executed at the communication services platform 120.

In some embodiments, responsive to a prompt (e.g., operation 228), the output of the generative AI model 170 can also include a function call that include one or more of the name of the function, the description of the function, parameter(s) of the function, and one or more values corresponding to the parameters. In some embodiments, the one or more values can be generated based on the user query. The structure of the function call can reflect the function definition and/or be defined by communication services platform 120. For example, the function definition can be used by the generative AI model 170 to generate an output in a structured data format (e.g., JavaScript Object Notation (JSON)) that includes a call to the function (e.g., function call) and/or can be used to call the function. For example, the output of the generative AI model 170 can be written in a data interchange format (e.g., JavaScript Object Notation (JSON)) that includes a function call (e.g., name, parameters and values). JSON can refer to a data interchange format that can be used to transmit data between a server and application (e.g., client device 110). In some embodiments, JSON data can be structured as key-value pairs.

In some embodiments, the function call can be defined by a particular schema. In some embodiments and as noted above, the schema can be reflected in the function definition and is used as a “template” for the generative machine learning model to generate the function call. The schema (e.g., JSON schema) can define one or more of properties, behaviors and/or data types (e.g., set of rules) that are acceptable for data (e.g., output of the generative AI model 170). The function definition can help direct the generative AI model 170 to produce an output that corresponds to a particular schema of the communication services platform 120.

At operation 204, client device 110 sends to communication services platform 120 an indication of an initialization of a virtual AI assistant. For example, client device 110A can launch application 154 that includes a GUI. The GUI can include a GUI element that, when selected, launches a virtual AI assistant user interface (e.g., also referred to as a virtual AI assistant, herein). The virtual AI assistant can receive user input and act on the user input based on a generative AI model 170. The virtual AI assistant can display answers to user queries as well as or in addition to other information, such as other information related to message delivery.

At operation 206, communication services platform 120 can obtain initial message data corresponding to the organization associated with the user account requesting initialization of the virtual AI assistant. It can be appreciated that in other embodiments, the obtained data can include other types of data (e.g., account data, voice data, etc.). In some embodiments, the virtual AI assistant can obtain that message data to provide initial message data for display in the virtual AI assistant. In some embodiments, the initial message data can be displayed via the virtual AI assistant without receiving a user query for information. For example, the initial message data can include “Your account has 808 deliverability errors in the last 7 days.”

At operation 208, communication services platform 120 can obtain question data (e.g., initial prompt data) used to formulate questions, topics or initial prompts for user selection via the virtual AI assistant. In some embodiments, the question data can relate to or help guide a user through message delivery management. For example, the questions can include “What are the common message errors?” or “What is undelivered versus failed status?” and so forth. The question data and corresponding questions and/or topics can help guide the user through the message delivery operations and/or troubleshooting, in some embodiments. In some embodiments, the question data can be displayed via the virtual AI assistant and function as queries (e.g., initial prompts) upon selection by a user of client device 110. In some embodiments, the questions can be provided for display in the virtual AI assistant without receiving a user query for information.

In some embodiments, the question data can include predetermined questions and retrieved from a data store associated with the communication services platform 120. In some embodiments, the question data can be determined specific to a user account, an organizational account, or a user cluster to which the user associated with the user account corresponds. For example, the communication services platform 120 can determine as question data for the most frequently asked questions for a particular organization, user account or user cluster.

At operation 210, communication services platform 120 can send to the AI model service 175 one or more of the question data and message data. In some embodiments, the question data can include unstructured data, such as natural language text. In some embodiments, the message data can include structured data such as a JSON object. In some embodiments, the communication services platform 120 can send separate prompts for each of the question data and message data. In an example, the communication services platform 120 can send the question data identifying frequently asked questions for a particular organization (or common topics addressing message delivery management) and ask the AI model service 175 to provide a summary of the question data.

At operation 212, AI model service 175 can provide a response to the prompt of operation 210. In some embodiments, the response is provided in an unstructured format, such as a natural language response.

At operation 214, communication services platform 120 performs data formatting of one or more of the initial message data, question data, or response to prompt to format the data for presentation in the virtual AI assistant.

At operation 216, communication services platform 120 provides client device 110 the formatted data for display at virtual AI assistant. Turning to FIG. 3A, FIG. 3A illustrates a virtual AI assistant user interface, in accordance with some embodiments. Virtual AI assistant 300 shows an example of the virtual AI assistant providing initial information at initialization of the virtual AI assistant 300 (e.g., without a user query). GUI element 302 illustrates the initial message data represented in natural language (e.g., unstructured data). GUI element 304 illustrates an input field that a user can input data, such as questions in natural language. GUI elements 306 illustrate a rendering of question data. In some embodiments, any one of GUI elements 306 can be selected as a user query.

Returning to FIG. 2, at operation 218, client device 110 sends to communication services platform 120 a query with first unstructured data via virtual AI assistant. For example, the first unstructured query can include a natural language query received via the input field of the virtual AI assistant. For example, the natural language query can include, “Can you give me a list of top error codes from my messaging account?” In an alternative embodiment, client device 110 sends to communication services platform 120 an indication of a user-selection of one of the GUI elements (e.g., GUI elements 306 of FIG. 3A).

At operation 220, communication services platform 120 can send to AI model service 175 a prompt to determine whether the subject matter of the query (e.g., operation 218) is permitted subject matter. In some embodiments, the virtual AI assistant can pertain to one or more specific subject matters (e.g., categories) and one or more specific sub-subject matters (e.g., sub-categories). For example, the virtual AI assistant can pertain message delivery management. The virtual AI assistant can assist in message delivery management but may not assist with other subject matters, such as the current or forecasted weather. In some embodiments, the virtual AI assistant within message delivery can pertain to message errors but not pertain to the content of specific messages that have been delivered. The communication services platform 120 can determine whether the subject matter and/or sub-subject matter of the user query is subject matter and/or sub-subject matter that the virtual AI assistant can assist with.

In some embodiments, the request to determine whether the user query pertains to permitted subject matter can include a prompt. In some embodiments, the prompt can include the user query (e.g., natural language query) and a subject matter prompt element (e.g., contextual information) indicating the permitted subject matter of the virtual AI assistant. For example, the prompt can include the natural language query (e.g., “What is the weather going to be today?”) and the subject matter prompt element (e.g., “Does the query pertain to message delivery management?”).

At operation 222, AI model service 175 sends to communication services platform 120 a response to the request indicating whether the subject matter of the user query is permitted subject matter. In some embodiments, the response is provided in an unstructured format, such as natural language. In an example, the response can include “The question, ‘What is the weather going to be today?’ does not pertain message delivery management.” In another example, the response can include “The question, ‘What is the most common message delivery error?’ does pertain to message delivery management.”

At operation 224, communication services platform 120 determines whether the subject matter of the user query is permitted subject matter. In some embodiments, to determine whether the subject matter of the user query is permitted subject matter the communication services platform 120 can evaluate the response from the AI model service 175. In some embodiments, the communication services platform 120 does not use the AI model service 175 to determine whether the subject matter of the user query is permitted. For example and in some embodiments, the communication services platform 120 can perform a keyword search of the query and determine whether any of the words pertains to permitted subject matter.

At operation 226, responsive to determining that the subject matter of the user query is not permitted subject matter, communication services platform 120 can send a notification to client device 110 indicating that the subject matter of the user query is not permitted. For example, the communication services platform 120 can send a message via the virtual AI assistant indicating that the virtual AI assistant cannot assist with query and inform the user that the virtual AI assistant can assist with questions pertaining to message delivery.

At operation 228, communication services platform 120 sends AI model service 175 a request with the first unstructured data of the user query and an identifier of the function. In some embodiments, operation 228 is performed responsive to determining that subject matter of the query is permitted. In some embodiments, communication services platform 120 generates a prompt using the user query (e.g., first unstructured data) and contextual information, such as the function identifier (also referred to as “API identifier” herein). In some embodiments, the first unstructured data includes the natural language query. In some embodiments, the contextual information includes a function identifier that references the function previously specified at operation 202. In some embodiments, the contextual information includes a function definition as described with respect to operation 202. For instance, the contextual information can include one or more of the name, description, parameters and metadata of the function or API call.

A single function and function definition is described herein for the sake of illustration, rather than limitation. In some embodiments, one or more functions and/or function definitions can be implemented. For instance, a prompt of operation 228 can include multiple function definitions and the AI model service 175 can determine which among the function definitions to use with the user query.

At operation 230, AI model service 175 generates a response based on the prompt and/or the function definition. In some embodiments, the response includes first structured data based on the function definition. The schema of the first structured data can reflect the schema of the function definition (e.g., defined by communication services platform 120). In some embodiments, the first structured data can include a function call based on the function definition provided in the prompt (e.g., operation 228) or provided at operation 202. In some embodiments, the first structured data can be formatted in a data interchange format, such as a JSON object. In some embodiments, the first structured data identifies a database query (e.g., information that can be used for a database query). In some embodiments, the first structured data can identify an API call (e.g., an API call for the communication services platform 120 or used to generate an API call at the communication services platform 120 to retrieve and aggregate the message data specified in the first structured data). In some embodiments, the API call can be used to perform a database query.

For example, the user query can include the question, “Can you give me a list of top error codes from my messaging account?” The user query and function identifier can be sent to AI model service 175 as a prompt. The AI model service 175 can return a JSON object that defines an API call for the communication services platform 120.

FIG. 3B illustrates a response with structured data based on a function, in accordance with some embodiments. Response 310 (also referred to as “structured data 310” herein) illustrates structured data (e.g., JSON object) that identifies a function call that can be used to retrieve and aggregate information about messages (e.g., message data) as communication services platform 120. The function call can be used, at least in part, to perform an API call for a database query to retrieve information about messages. The structured data can be formatted based on a schema defined by the communication services platform 120. For instance, the function call can be formatted in a format specific to communication services platform 120. The function call is directed to finding messages within a specified week that failed, were undelivered, or had an unknown delivery status, and group the results by error code and status to analyze the common errors and their distribution.

Returning to FIG. 2, at operation 232, communication services platform 120 generates one or more database queries based on the first structured data of the response of operation 230. In some embodiments, communication services platform 120 performs or generates one or more API calls based on the first structured data of the response. In some embodiments, the API call of the response, is used as an API call to the communication services platform 120 that invokes one or more database queries. In some embodiments, the API call of the response, and in particular is used to perform the one or more database queries.

At operation 234, communication services platform 120 obtains second structured data. In some embodiments, the second structured data is retrieved based on the first structured data. In some embodiments, the second structured data identifies message data based on the one or more database queries.

In some embodiments, the communication services platform 120 uses the first structured data (e.g., function call) of operation 230 to generate an internal API call to retrieve the requested information. The requested information can be information that can be retrieved in a structured format, such as a JSON object.

For example, FIG. 3C illustrates structured data obtained by the SaaS platform, in accordance with some embodiments. Response 320 (also referred to as “structured data 320” herein) illustrates structured data (e.g., JSON object) generated by communication services platform 120 based on the structured data (of response 320 of FIG. 3B) that identified an API call (e.g., or function call). For the sake of brevity, a portion of the structured data is represented in FIG. 3C. The structured data 320 can detail issues related to messages. Each issue can be identified by a unique key and characterized by specific fields, such as error code, status, total occurrences and priority.

Returning to FIG. 2, at operation 236, communication services platform 120 sends a prompt to AI model service 175 with at least some (or only a part) of structured data 320 of operation 230. In some embodiments, the structured data 320 is not formatted in a manner that is readily available for consumption by the user. Communication services platform 120 can send at least some of the structured data 320 to AI model service 175 such that the structured data is converted into unstructured data, such as a natural language.

At operation 238, AI model service 175 sends to communication services platform 120 a reply that includes unstructured data that represents the structured data of operation 236. For example and in some embodiments, AI model service 175 sends a natural language reply that reflects the structured data of 236.

At operation 240, communication services platform 120 performs data formatting on the message data to format the data for presentation at the virtual AI assistant of client device 110. In some embodiments, the unstructured data of operation 238 is used, at least in part, as information formatted for presentation at the virtual AI assistant. In some embodiments, at least some of the structured data 320 is used as information that is formatted for presentation at the virtual AI assistant.

At operation 242, communication services platform 120 provides message data for display at the virtual AI assistant at the client device 110.

Turning to FIG. 3D, FIG. 3D illustrates a virtual AI assistant user interface, in accordance with some embodiments. Virtual AI assistant 330 shows an example of the virtual AI assistant providing message data in response to a user query. GUI element 332 illustrates the user query as described with respect to operation 218. GUI element 334 shows message data formatted in natural language. GUI element 334 can represent the unstructured message data received from AI model service 175 at operation 238. GUI element represents message data structured in a table. The message data of GUI element 336 can be obtained from structure data 320 (e.g., response 320) represented in FIG. 3C and/or described at operation 234. GUI element 304 illustrates an input field that a user can input data, such as questions in natural language.

FIG. 4A through 4E illustrate features of an interactive guidance system using a virtual AI assistant, in accordance with some embodiments of the disclosure. The interactive guidance system can be used to implement a guided flow that assists and guides users in an interactive manner through features of message delivery management. For example, users can monitor message deliverability issues to address causes of messaging errors. In some cases, the users can report issues pertaining to messaging deliverability by submitting support tickets for technical assistance in troubleshooting. Message error investigation can be a complex task. The virtual AI assistant, as described herein, can be used to simplify error investigation tasks and be used to retrieve immediate and actionable insights using a conversational and interactive environment.

FIG. 4A illustrates a virtual AI assistant user interface, in accordance with some embodiments. Virtual AI assistant 400 shows an example of the virtual AI assistant providing initial information at initialization of the virtual AI assistant 400 (e.g., without a user query). GUI element 402 illustrates the initial message data represented in natural language (e.g., unstructured data). As illustrated, GUI element 402 includes specific information related to the client and pertains to message delivery management. The virtual AI assistant 400 can evaluate all message traffic associated with a client's account. The error analysis can be customized based on each client's account messaging traffic, delivery statistics, and/or error status. GUI elements 404 illustrated a rendering of question data. In the present example, the question data reflects topics related to causes of message errors. The topics can include but are not limited to subaccounts, countries, carriers, error codes, individual messages, phone numbers, channels (SMS, MMS, rich communication services (RCS), messaging applications), messaging services, status, opt-out responses, among others.

Selection of a particular one of GUI elements 404 can initiate guidance to the user through a particular topic of message delivery management. GUI element 406 illustrates an input field that a user can input data, such as questions in natural language. For example, a user can select from among GUI elements 406, a GUI element pertaining to error codes, phone numbers, subaccounts, or countries. Additionally, a user can enter a message identifier (e.g., via GUI element 404 “I have a message to troubleshoot”) to view an issue pertaining to a specific message. A user can use either the topics presented via GUI elements 404 or a natural language query via GUI element 406 to investigate messaging error and/or be guided through troubleshooting of message errors.

In some embodiments, the suggested questions and topics are personalized and/or customized to individual customers (e.g., user accounts and/or organizational accounts) that are interacting with the virtual AI assistant based on the customer's specific data. The questions and topics can be different for different individual users and/or different customers (e.g., organizational level). The interactive guidance system can guide a user through troubleshooting and a recommendation path by highlighting the most important paths in the beginning (e.g., initial virtual AI assistance). It should be noted that the features described with respect to FIG. 4A though 4E can be implemented as described herein, and in particular using the operations described with respect to FIG. 2 through 3D. The selection of GUI elements, such as GUI elements 404 and the resultant actions (e.g., information retrieval and rendering of a virtual AI assistant to display the information) can be implemented in a similar manner as actions resulting from a natural language query. For example, one or more of operations 228 through 242 can be implemented responsive to a selection of a GUI element 404 pertaining to a particular message topic.

FIG. 4B illustrates an example of a message troubleshooting flow facilitated by a virtual AI assistant and related to message delivery management, in accordance with some embodiments of the disclosure. As illustrated, guided flow 410 includes branches 412 through 420 that correspond to the topics of GUI elements 404 of FIG. 3A. It should be noted that although selecting a GUI element is described as initiating a particular branch of the guided flow, the branch can be initiated and/or subsequent operations implemented using GUI selection, natural language queries, or a combination thereof, in some embodiments.

Branch 412 represents a troubleshooting flow for viewing message issues by error code. In some embodiments, responsive to a user selecting the “Error Codes” GUI element, branch 412 can be implemented. At branch 412, the virtual AI assistant can present an analysis of message errors by error codes. A user can select a specific error code and the virtual AI assistant can display all the messages associated with a selected error code. A user can select an error code and the virtual AI assistant can display the reasons behind the errors and potential solutions.

In some embodiments, responsive to a user selecting the “Phone Numbers” GUI element, branch 414 can be implemented. At branch 414, the virtual AI assistant can present an analysis of phone numbers with error counts. A user can select a specific phone number and the virtual AI assistant can display all the message errors associated with a selected phone number. A user can select an error code and the virtual AI assistant can display the reasons behind the message errors and potential solutions.

In some embodiments, responsive to a user selecting the “Subaccounts” GUI element, branch 416 can be implemented. At branch 416, the virtual AI assistant can present an analysis of sub-account (e.g., under a customer's parent account) with error counts. A user can select a specific sub-account and the virtual AI assistant can display all the message errors associated with a selected sub-account. A user can select an error code and the virtual AI assistant can display the reasons behind the message errors and potential solutions.

In some embodiments, responsive to a user selecting the “Countries” GUI element, branch 418 can be implemented. At branch 418, the virtual AI assistant can present an analysis of countries (where messages are sent) with error counts. A user can select a specific country and the virtual AI assistant can display all the message errors associated with a selected country. A user can select an error code and the virtual AI assistant can display the reasons behind the message errors and potential solutions.

In some embodiments, responsive to a user selecting the “I have a message to troubleshoot” GUI element and entering or selecting a message identifier, branch 420 can be implemented. At branch 420, the virtual AI assistant can present an analysis of message errors associated with a particular message ID. A user can select an error code and the virtual AI assistant can display the reasons behind the message errors and potential solutions.

FIGS. 4C and 4D illustrate examples of a virtual AI assistant user interface, in accordance with some embodiments. Virtual AI assistant 430 shows an example of the virtual AI assistant providing error analysis responsive to a user selecting “Error Code” GUI element (e.g., of FIG. 3A). Virtual AI assistant 440 shows an example of the virtual AI assistant providing error analysis responsive to a user using a natural language query, “What are undelivered vs. failed message status?” It can be appreciated that although the display of information is different between virtual AI assistant 430 and 440, the content of the information is similar. Each of virtual AI assistant 430 and virtual AI assistant 440 start at branch 412 of guided flow 410 as described with respect to FIG. 4B.

FIG. 4E illustrates potential solutions to message errors presented by a virtual AI assistant, in accordance with some embodiments of the disclosure. Diagram 450 illustrates simplified branches 452 and 544 for a guided flow. Branch 450 is similar to branch 412 of FIG. 4B. Brach 450 is initiated when a user selects an “Error Code” GUI element in the initial virtual AI assistant user interface. Branch 452 is initiated responsive to a user submitting a natural language query pertaining to error codes (e.g., “Why were my messages undelivered with (this error) yesterday?”). Information 456 illustrates information displayed by the virtual AI assistant identifying reasons behind the message errors and potential solutions.

For example, the virtual AI assistant can examine message traffic for a specified period. The virtual AI assistant can identify deliverability issues that may be due to an increased number of opt-outs or spam complaints for the messages (e.g., text messages). The virtual AI assistant can display specific recommendations to reduce opt-outs and spam complaints. For instance, some actionable items provided by the virtual AI assistant can include ensuring permission is obtained before sending messages, maintaining an updated contact list to ensure recipients still wish to receive messages, validating that messages comply with legal and content standards, adhering to country-specific SMS guidelines, avoiding spam triggers like excessive use of caps or exclamation marks, actively managing contact lists, and revisiting consent processes to address potential rise in opt-outs or spam complaints, among others.

In some embodiments, the virtual AI assistant can identify and recommend one or more services to help the client address the issues. In some embodiments, the virtual AI assistant can collect feedback from the user regarding the user's interaction with the virtual AI assistant. In some embodiments, the virtual AI assistant can be used to request live support (e.g., support from a human operator).

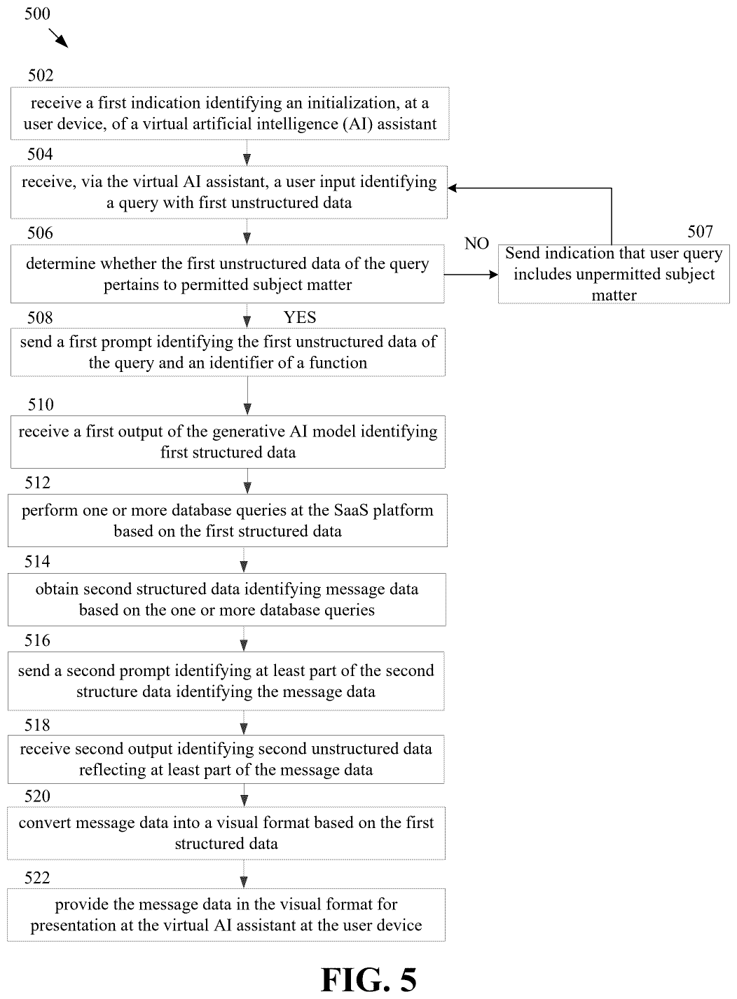

Method 500 of FIG. 5 and/or each of the aforementioned method's individual functions, routines, subroutines, or operations can be performed by a processing device, having one or more processing units (CPU) and memory devices communicatively coupled to the CPU(s). In some embodiments, the method 500 can be performed by a single processing thread or alternatively by two or more processing threads, each thread executing one or more individual functions, routines, subroutines, or operations of the method. Method 500 as described below can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, method 500 is performed by virtual AI assistant module 151 described in FIGS. 1 and 2. Although shown in a particular sequence or order, unless otherwise specified, the order of the operations can be modified. Thus, the illustrated embodiments should be understood only as examples, and the illustrated operations can be performed in a different order, while some operations can be performed in parallel. Additionally, one or more operations can be omitted in some embodiments. Thus, not all illustrated operations are required in every embodiment, and other process flows are possible. In some embodiments, the same, different, fewer, or greater operations can be performed. It may be noted that elements of FIG. 1-3 may be used herein to help describe FIG. 5.

FIG. 5 depicts a flow diagram of an example method 500 for prompt generation for a virtual AI assistant, in accordance with some embodiments of the disclosure. In some embodiments, method 500 can be performed by communication services platform 120, and in particular virtual AI assistant module 151 of communication services platform 120.

At operation 502, processing logic receive a first indication identifying an initialization, at a user device, of a virtual artificial intelligence (AI) assistant. In some embodiments the first indication is received at a SaaS platform. In some embodiments, the virtual AI assistant is for message delivery management at the SaaS platform.

At operation 504, processing logic receives, via the virtual AI assistant, a user input identifying a query with first unstructured data. In some embodiments, the user input is received at the SaaS platform.

At operation 506, processing logic determines whether the first unstructured data of the query pertains to permitted subject matter. In some embodiments, to determine whether the first unstructured data of the query pertains to the permitted subject matter, processing logic sends, via a third API call to the generative AI model, third prompt identifying the first unstructured data of the query and contextual information identifying the permitted subject matter. In some embodiments, to determine whether the first unstructured data of the query pertains to the permitted subject matter, processing logic receives a third output of the generative AI model indicating whether the first unstructured data of the query relates to the message delivery management.

If processing logic determines that the first unstructured data of the query pertains to unpermitted subject matter, processing logic proceeds to operation 507. If processing logic determines that the first unstructured data of the query pertains to permitted subject matter, processing logic proceeds to operation 508.

At operation 507, processing logic sends an indication, via the virtual AI assistant, that the user query includes unpermitted subject matter.

At operation 508, processing logic sends a first prompt identifying the first unstructured data of the query and an identifier of a function. In some embodiments, sending the first prompt identifying the first unstructured data of the query and the identifier of the function is responsive to determining that the first unstructured data of the query pertains to the permitted subject matter related to the message delivery management. In some embodiments, processing logic sends the first prompt via a first API call to a generative AI model. In some embodiments, the identifier of the function includes a function definition including one or more parameters for the function. In some embodiments, the one or more parameters defined by the SaaS platform

At operation 510, processing logic receives a first output of the generative AI model identifying first structured data. In some embodiments, the first structured data is related to the message delivery management. In some embodiments, the first output of the generative AI model is based on the function. In some embodiments, the first structured data identifies an API call for a database query related to retrieving message data stored at the SaaS platform. In some embodiments, the message data pertains to messages of one or more of short messaging service (SMS) channel, a multimedia messaging service (MMS) channel, or an instant messaging service channel. In some embodiments, the first structured data of the first output of the generative AI model includes an API call related to the message delivery management. In some embodiments, the API call includes the one or more parameters and corresponding one or more values of the one or more parameters.

At operation 512, processing logic performs one or more database queries at the SaaS platform based on the first structured data.

At operation 514, processing logic obtains second structured data identifying message data based on the one or more database queries.

At operation 516, processing logic sends a second prompt identifying at least part of the second structure data identifying the message data. In some embodiments, the second prompt is sent via an API call to the generative AI model.

At operation 518, processing logic receives second output identifying second unstructured data reflecting at least part of the message data. In some embodiments, the second unstructured data is provided for presentation at the virtual AI assistant at the user device.

At operation 520, processing logic converts message data into a visual format based on the first structured data.

At operation 522, processing logic provides the message data in the visual format for presentation at the virtual AI assistant at the user device.

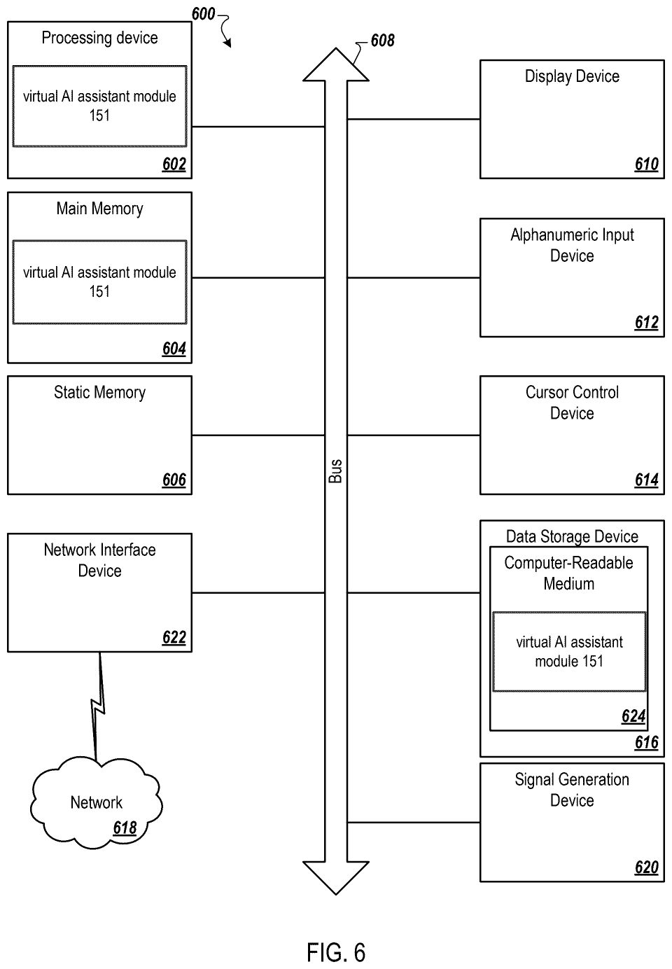

FIG. 6 is a block diagram illustrating an exemplary computer system 600, in accordance with an embodiment of the disclosure. The computer system 600 executes one or more sets of instructions that cause the machine to perform any one or more of the methodologies discussed herein. Set of instructions, instructions, and the like may refer to instructions that, when executed by computer system 600, cause computer system 500 to perform one or more operations of virtual AI assistant module 151. The machine may operate in the capacity of a server or a client device in a client-server network environment, or as a peer machine in a peer-to-peer (or distributed) network environment. The machine may be a personal computer (PC), a tablet PC, a set-top box (STB), a personal digital assistant (PDA), a mobile telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute the sets of instructions to perform any one or more of the methodologies discussed herein.

The computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage device 616, which communicate with each other via a bus 608.

The processing device 602 represents one or more general-purpose processing devices such as a microprocessor, central processing unit, or the like. More particularly, the processing device 602 may be a complex instruction set computing (CISC) microprocessor, reduced instruction set computing (RISC) microprocessor, very long instruction word (VLIW) microprocessor, or a processing device implementing other instruction sets or processing devices implementing a combination of instruction sets. The processing device 602 may also be one or more special-purpose processing devices such as an application specific integrated circuit (ASIC), a field programmable gate array (FPGA), a digital signal processor (DSP), network processor, or the like. The processing device 602 is configured to execute instructions of the system architecture 100 and virtual AI assistant module 151 for performing the operations discussed herein.

The computer system 600 may further include a network interface device 622 that provides communication with other machines over a network 618, such as a local area network (LAN), an intranet, an extranet, or the Internet. The computer system 600 also may include a display device 610 (e.g., a liquid crystal display (LCD) or a cathode ray tube (CRT)), an alphanumeric input device 612 (e.g., a keyboard), a cursor control device 614 (e.g., a mouse), and a signal generation device 620 (e.g., a speaker).

The data storage device 616 may include a non-transitory computer-readable storage medium 624 on which is stored the sets of instructions of the system architecture 100 of virtual AI assistant module 151 embodying any one or more of the methodologies or functions described herein. The sets of instructions of the system architecture 100 and of virtual AI assistant module 151 may also reside, completely or at least partially, within the main memory 604 and/or within the processing device 602 during execution thereof by the computer system 600, the main memory 604 and the processing device 602 also constituting computer-readable storage media. The sets of instructions may further be transmitted or received over the network 618 via the network interface device 622.

While the example of the computer-readable storage medium 624 is shown as a single medium, the term “computer-readable storage medium” can include a single medium or multiple media (e.g., a centralized or distributed database, and/or associated caches and servers) that store the sets of instructions. The term “computer-readable storage medium” can include any medium that is capable of storing, encoding or carrying a set of instructions for execution by the machine and that causes the machine to perform any one or more of the methodologies of the disclosure. The term “computer-readable storage medium” can include, but not be limited to, solid-state memories, optical media, and magnetic media.

In the foregoing description, numerous details are set forth. It will be apparent, however, to one of ordinary skill in the art having the benefit of this disclosure, that the disclosure may be practiced without these specific details. In some instances, well-known structures and devices are shown in block diagram form, rather than in detail, in order to avoid obscuring the disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It may be borne in mind, however, that all of these and similar terms are to be associated with the appropriate physical quantities and are merely convenient labels applied to these quantities. Unless specifically stated otherwise, it is appreciated that throughout the description, discussions utilizing terms such as “authenticating”, “providing”, “receiving”, “identifying”, “determining”, “sending”, “enabling” or the like, refer to the actions and processes of a computer system, or similar electronic computing device, that manipulates and transforms data represented as physical (e.g., electronic) quantities within the computer system memories or registers into other data similarly represented as physical quantities within the computer system memories or registers or other such information storage, transmission or display devices.

The disclosure also relates to an apparatus for performing the operations herein. This apparatus may be specially constructed for the required purposes, or it may include a general-purpose computer selectively activated or reconfigured by a computer program stored in the computer. Such a computer program may be stored in a computer readable storage medium, such as, but not limited to, any type of disk including a floppy disk, an optical disk, a compact disc read-only memory (CD-ROM), a magnetic-optical disk, a read-only memory (ROM), a random access memory (RAM), an erasable programmable read-only memory (EPROM), an electrically erasable programmable read-only memory (EEPROM), a magnetic or optical card, or any type of media suitable for storing electronic instructions.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims may generally be construed to mean “one or more” unless specified otherwise or clear from context to be directed to a singular form. Moreover, use of the term “an implementation” or “one implementation” or “an embodiment” or “one embodiment” throughout is not intended to mean the same implementation or embodiment unless described as such. The terms “first,” “second,” “third,” “fourth,” etc. as used herein are meant as labels to distinguish among different elements and may not necessarily have an ordinal meaning according to their numerical designation.

For simplicity of explanation, methods herein are depicted and described as a series of acts or operations. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

In additional embodiments, one or more processing devices for performing the operations of the above-described embodiments are disclosed. Additionally, in embodiments of the disclosure, a non-transitory computer-readable storage medium stores instructions for performing the operations of the described embodiments. Also in other embodiments, systems for performing the operations of the described embodiments are also disclosed.

It is to be understood that the above description is intended to be illustrative, and not restrictive. Other embodiments will be apparent to those of skill in the art upon reading and understanding the above description. The scope of the disclosure may, therefore, be determined with reference to the appended claims, along with the full scope of equivalents to which such claims are entitled.

What is claimed is:

1. A method, comprising:
receiving, at a software as a service (SaaS) platform, a first indication identifying an initialization, at a user device, of a virtual artificial intelligence (AI) assistant for message delivery management at the SaaS platform;
receiving, via the virtual AI assistant and at the SaaS platform, a user input identifying a query with first unstructured data;
sending, via a first application programming interface (API) call to a generative AI model, a first prompt identifying the first unstructured data of the query and an identifier of a function related to the message delivery management at the SaaS platform; and
receiving a first output of the generative AI model identifying first structured data related to the message delivery management based on the function.

2. The method of claim 1, wherein the first structured data identifies an API call for a database query related to retrieving message data stored at the SaaS platform.

3. The method of claim 2, wherein the message data pertains to messages of one or more of a short messaging service (SMS) channel, a multimedia messaging service (MMS) channel, or an instant messaging service channel.

4. The method of claim 2, further comprising:
converting message data into a visual format based on the first structured data; and
providing the message data in the visual format for presentation at the virtual AI assistant at the user device.

5. The method of claim 4, further comprising:
performing one or more database queries at the SaaS platform based on the first structured data; and
obtaining second structured data identifying the message data based on the one or more database queries.

6. The method of claim 5, further comprising:
sending, via a second API call to the generative AI model, a second prompt identifying at least part of the second structure data identifying the message data; and
receiving second output of the generative AI model identifying second unstructured data reflecting at least part of the message data, wherein the second unstructured data is provided for presentation at the virtual AI assistant at the user device.

7. The method of claim 1, wherein the identifier of the function comprises a function definition including one or more parameters for the function, the one or more parameters defined by the SaaS platform.

8. The method of claim 7, wherein the first structured data of the first output of the generative AI model comprises an API call related to the message delivery management, the API call comprising the one or more parameters and corresponding one or more values of the one or more parameters.

9. The method of claim 1, further comprising:
determining whether the first unstructured data of the query pertains to permitted subject matter, and
wherein sending the first prompt identifying the first unstructured data of the query and the identifier of the function is responsive to determining that the first unstructured data of the query pertains to the permitted subject matter related to the message delivery management.

10. The method of claim 9, wherein determining whether the first unstructured data of the query pertains to the permitted subject matter, comprises:
sending, via a third API call to the generative AI model, third prompt identifying the first unstructured data of the query and contextual information identifying the permitted subject matter; and
receiving a third output of the generative AI model indicating whether the first unstructured data of the query relates to the message delivery management.

11. The method of claim 1, wherein the virtual AI assistant is configured to provide a personalized interactive guide through topics of message delivery management using client-specific data.

12. A system comprising:
a memory; and
a processing device, coupled to the memory, to perform operations comprising:
receiving, at a software as a service (SaaS) platform, a first indication identifying an initialization, at a user device, of a virtual artificial intelligence (AI) assistant for message delivery management at the SaaS platform;
receiving, via the virtual AI assistant and at the SaaS platform, a user input identifying a query with first unstructured data;
sending, via a first application programming interface (API) call to a generative AI model, a first prompt identifying the first unstructured data of the query and an identifier of a function related to the message delivery management at the SaaS platform; and
receiving a first output of the generative AI model identifying first structured data related to the message delivery management based on the function.

13. The system of claim 12, wherein the first structured data identifies an API call for a database query related to retrieving message data stored at the SaaS platform.

14. The system of claim 13, the operations further comprising:
converting message data into a visual format based on the first structured data; and
providing the message data in the visual format for presentation at the virtual AI assistant at the user device.

15. The system of claim 14, the operations further comprising:
performing one or more database queries at the SaaS platform based on the first structured data; and
obtaining second structured data identifying the message data based on the one or more database queries.

16. The system of claim 15, the operations further comprising:
sending, via a second API call to the generative AI model, a second prompt identifying at least part of the second structure data identifying the message data; and
receiving second output of the generative AI model identifying second unstructured data reflecting at least part of the message data, wherein the second unstructured data is provided for presentation at the virtual AI assistant at the user device.

17. The system of claim 12, wherein the identifier of the function comprises a function definition including one or more parameters for the function, the one or more parameters defined by the SaaS platform.

18. A non-transitory computer-readable medium comprising instructions that, responsive to execution by a processing device cause the processing device to perform operations comprising:
receiving, at a software as a service (SaaS) platform, a first indication identifying an initialization, at a user device, of a virtual artificial intelligence (AI) assistant for message delivery management at the SaaS platform;
receiving, via the virtual AI assistant and at the SaaS platform, a user input identifying a query with first unstructured data;
sending, via a first application programming interface (API) call to a generative AI model, a first prompt identifying the first unstructured data of the query and an identifier of a function related to the message delivery management at the SaaS platform; and
receiving a first output of the generative AI model identifying first structured data related to the message delivery management based on the function.

19. The non-transitory computer-readable medium of claim 18, wherein the first structured data identifies an API call for a database query related to retrieving message data stored at the SaaS platform.

20. The non-transitory computer-readable medium of claim 19, the operations further comprising:
converting message data into a visual format based on the first structured data; and
providing the message data in the visual format for presentation at the virtual AI assistant at the user device.
